(19) United States
(12) Patent Application Publication
(10) Pub. No.: US 2015/0275997 A1
(43) Pub. Date: Oct. 1, 2015

(54) VARIABLE RATE FRICTION DAMPER

(71) Applicant: Burton Technologies, LLC, Ludington, MI (US)

(72) Inventor: John E. Burton, Ludington, MI (US)

(73) Assignee: BURTON TECHNOLOGIES, LLC, Ludington, MI (US)

(21) Appl. No.: 14/664,566

(22) Filed: Mar. 20, 2015

Related U.S. Application Data
(60) Provisional application No. 61/971,833, filed on Mar. 28, 2014.
(60) Provisional application No. 62/103,687, filed on Jan. 15, 2015.

(51) Int. Cl. F16F 1/06; E05F 5/02; E05F 5/08; F16F 15/121

(52) U.S. Cl. CPC F16F 1/06; F16F 15/1213; E05F 5/02; E05F 5/08

(57) ABSTRACT

A variable rate friction damper has variable torque dampening resistance without the use of oil. The variable rate friction damper uses interference friction to generate variable torque dampening resistance depending on the rotational position of the damper.

### CROSS-REFERENCE TO RELATED APPLICATION

This application is based on and claims priority to U.S. Provisional Patent Application No. 61/971,833 filed on Mar. 28, 2014, and U.S. Provisional Patent Application No. 62/103,687 filed on Jan. 15, 2015, which are incorporated herein by reference in their entirety for all purposes.

### FIELD OF THE INVENTION

The present invention relates generally to the field of rotary dampers. More particularly, the present invention relates to rotary dampers used for controlling the motion of lids, doors or handles that rotate less than a full rotation.

### BACKGROUND

Rotating handles, lids, or compartment doors are used in a wide variety of applications, many of which are related to use in vehicles. One common use of rotating handles is in the automotive industry, where rotating grab handles are often provided above the doors in the interior of a vehicle. A common use of rotating lids or compartment doors is also in the automotive industry, where many vehicles include rotating doors to provide access to storage compartments for sunglasses or other small items.

Rotating handles or compartment doors like the ones described above typically rotate from 90 to 120 degrees and typically include a wound wire torsion spring that biases the rotation of the object in either an open or closed position.

In the case of a typical grab handle like those above vehicle doors, a torsion spring keeps the handle in the up position. When grabbed, the handle swings down for use to help passengers get in and out of the vehicle. When the handle is released the spring returns the handle back to the up position out of the way. The spring preload torque increases as the handle is pulled from the up position to the down position and must be great enough to lift the weight of the handle. Rotary dampers are used to smooth the spring close motion as the handle returns to the up position so not to have an unpleasant impacting sound.

In the case of a drop down storage compartment such as those used for storing sunglasses in an automobile the spring preload torque is highest in the up and latched position. When the latch is released the torsion spring helps to swing the compartment door open and hold it on the fully open position. The spring preload torque is lowest in the down and fully open position. Rotary dampers are used to smooth the spring open motion as the door fully opens so not to have an impact sound when opened.

Wound wire torsion springs are largely used with grab handles and compartment doors because they are compact and inexpensive. Hooke's law is a principle of physics that states that the force needed to extend or compress a spring by some distance is proportional to that distance. Torsion springs operate in the same manner and have a ‘spring rate’ which defines the linear rate of torque increase per degree of rotation within the elastic range of the spring. The design objectives that determine the specification of a rotary damper is to have enough resistance to counter the spring torque and prevent impact but not so much resistance that achieving the full range of motion is prevented or is too slow. Design objectives have been typically set to achieve the full range of rotational motion within a couple seconds and do this over a wide temperature range typically between −40 and 180 degrees F.

Achieving these design objectives has been problematic for both friction type dampers like the one shown in U.S. Pat. No. 4,571,773 and oil type dampers like the one shown in U.S. Pat. No. 5,497,863. Friction type dampers have more consistent constant torque resistance than the oil type damper. In friction dampers, material selection can contribute to variations in static and dynamic friction. Static friction is typically higher than dynamic friction, but dynamic friction is largely unchanged by speed and produces a near constant resistance. This can be a problem because torsion spring torque changes with angle. Thus, for the torsion spring to provide enough force to achieve a full range of motion, the friction damper resistance torque must always be less than the lowest spring torque preload. However, selecting a suitable torsion spring or damper materials is difficult and often leads to a situation where the resistance torque is inadequate and the motion is too slow, too quick, or undesirable impact occurs.

The oil type damper entails problems of its own which, unlike the problems suffered by the friction type damper, are ascribable to the use of oil. In oil type dampers, torque resistance increases as rotational speed increases. Thus, the lowest torque resistance is present when the oil damper is not moving. Silicone oil of high viscous drag is typically used in oil type dampers. This oil has a high thermal expansion coefficient and expands as the temperature of the ambient air increases. Under certain conditions, such expansion the causes the oil to expand so much that it leaks from the damper. Conversely, when the ambient temperature falls, the oil within the housing contracts and in certain conditions the contraction is significant enough that there is not enough volume of the oil left in the damper, which may deprive the damper proportionately of its effect. Variation in viscosity with temperature change also changes the torque damping resistance resulting in a motion that is often too fast or too slow to meet design objectives.

As such, there is a need for a rotary damper that does not use oil and provides a variable torque dampening resistance to correspond with user requirements. Such a damper would provide for improved control of rotation despite variations in spring torque produced by a spring as it rotates, and further performs across a wide temperature range.

### SUMMARY

This invention relates to a variable rate friction damper for braking and absorbing opening and closing motions of an opening-closing object such as a rotating handle, lid or compartment door. One embodiment of a variable rate friction damper in accordance with the invention includes a housing having a generally cylindrical recess and having an inside surface. A spring clip having a generally cylindrical shape portion fits inside the recess. The spring clip includes a retention flange that engages a spring retention slot in the recess to prevent the spring clip from rotating relative to the housing during operation of the variable rate friction damper. The spring clip does not contact the surface of the recess. A rotor having a generally cylindrical shape and including a contact lobe is rotatably attached to the housing and has a portion positioned inside the spring clip so that the contact lobe engages an interior surface of the spring clip. As the rotor rotates, the contact lobe causing the spring clip to expand or contract depending on the direction of rotation, which increases or decreases the dampening torque generated by the variable rate friction damper. The spring clip may also include at least one protrusion on its inner surface to allow for a user to specify a desired dampening torque to correspond to a given angle of rotation.

Another embodiment of a variable rate friction damper in accordance with the invention includes a base having an arcuate portion with a first end and a second end. The arcuate portion has a ramped surface having a first thickness at the first end and a second thickness at the second end. A spring clip is attached to a rotor that is rotatably attached to the base. The spring clip has at least one contact surface engaged with the ramped surface so that as the rotor rotates the at least one contact surface travels along the ramped surface causing the spring clip to expand or contract depending on the direction of rotation which increases or decreases the dampening torque generated by the variable rate friction damper.

Yet another embodiment of a variable rate friction damper in accordance with the invention includes a housing including a generally cylindrical recess having an inside surface that has a helical rib running along it. A rotor having a generally cylindrical shape and including a helical groove running along an outside surface is rotatably attached to the housing. The helical rib selectively interferes with the helical groove so that the rotor may rotate with respect to the recess and so the interference force increases or decreases depending on the amount of interference between the helical rib and the helical groove.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of a vehicle grab handle having a torsion spring;

FIG. 1A is a chart showing the spring torque characteristics of the torsion spring of the vehicle grab handle of FIG. 1;

FIG. 2 is a perspective view of a vehicle drop down compartment arrangement having a torsion spring;

FIG. 2A is a chart showing the spring torque characteristics of the torsion spring of the vehicle drop down compartment of FIG. 2;

FIG. 3A is an exploded perspective view of one embodiment of a variable rate friction damper in accordance with the invention;

FIG. 3B is a side view of the variable rate friction damper of FIG. 3A;

FIG. 3C is a front view of the variable rate friction damper of FIG. 3A;

FIG. 3D is a section view of the variable rate friction damper of FIG. 3A taken along the line 3D-3D in FIG. 3C;

FIG. 4 is a side view of a cover ring in accordance with the invention;

FIG. 4A is a section view of the cover ring of FIG. 4 taken along the line 4A-4A in FIG. 4;

FIG. 4B is a section view of the cover ring of FIG. 4 taken along the line 4B-4B in FIG. 4;

FIG. 4C is a front view of the cover ring of FIG. 4;

FIG. 5 is a side view of a sleeve in accordance with the invention;

FIG. 5A is a front view of the sleeve of FIG. 5;

FIG. 5B is a section view of the sleeve of FIG. 5 taken along the line 5B-5B in FIG. 5;

FIG. 6 is a side view of a rotor in accordance with the invention;

FIG. 6A is a front view of the rotor of FIG. 6;

FIG. 6B is another side view of the rotor of FIG. 6

FIG. 6C is a section view of the rotor of FIG. 6 taken along line 6C-6C in FIG. 6A.

FIG. 7 is a side view of the sleeve of FIG. 5 rotatably attached to the rotor of FIG. 6, with the sleeve in a first position with respect to the rotor,

FIG. 7A is a front view of the sleeve of FIG. 5 rotatably attached to the rotor of FIG. 6, with the sleeve in a first position with respect to the rotor,

FIG. 8 is a side view of the sleeve of FIG. 5 rotatably attached to the rotor of FIG. 6, with the sleeve in a second position with respect to the rotor,

FIG. 8A is a side view of the sleeve of FIG. 5 rotatably attached to the rotor of FIG. 6, with the sleeve in a second position with respect to the rotor;

FIG. 9A is a torque angle graph that corresponds to the varied degrees of rotation of FIGS. 7 and 8;

FIG. 9B is a section view of the subassembly shown in FIG. 7 taken along line 9B-9B in FIG. 7 showing the sleeve in the first position with respect to the rotor;

FIG. 9C is a section view of the subassembly shown in FIG. 8 taken along line 9C-9C in FIG. 8 showing the sleeve in the second position with respect to the rotor,

FIG. 10 is a side view of one embodiment of a variable rate friction damper in accordance with the invention;

FIG. 10A is a front view of the variable rate friction damper of FIG. 10;

FIG. 10B is a back view of the variable rate friction damper of FIG. 10;

FIG. 11 is a perspective exploded view of the variable rate friction damper of FIG. 10;

FIG. 11A is another perspective exploded view of the variable rate friction damper of FIG. 10;

FIG. 12 is a front view of a housing of the variable rate friction damper of FIG. 10;

FIG. 12A is a section view of the housing of the variable rate friction damper of FIG. 10 taken along the line 12A-12A in FIG. 12;

FIG. 12B is a side view of the housing of the variable rate friction damper of FIG. 10;

FIG. 12C is a back view of the housing of the variable rate friction damper of FIG. 10;

FIG. 13 is a side view of a gear rotor of the variable rate friction damper of FIG. 10;

FIG. 13A is a front view of a gear rotor of the variable rate friction damper of FIG. 10;

FIG. 13B is a back view of a gear rotor of the variable rate friction damper of FIG. 10;

FIG. 14 is a front view of the variable rate friction damper of FIG. 10 showing the gear rotor in a first position;

FIG. 14A is a partial section view of the variable rate friction damper of FIG. 10 taken along line 14A-14A in FIG. 14;

FIG. 14B is a back view of the variable rate friction damper of FIG. 10;

FIG. 14C is a side view of the variable rate friction damper of FIG. 10;

FIG. 15 is a front view of the variable rate friction damper of FIG. 10 showing the gear rotor in a second position;

FIG. 15A is a partial section view of the variable rate friction damper of FIG. 10 taken along line 15A-15A in FIG. 15;

FIG. 15B is a back view of the variable rate friction damper of FIG. 10;

FIG. 15C is a side view of the variable rate friction damper of FIG. 10;

FIG. 16 is an exploded perspective view of one embodiment of a variable rate friction damper in accordance with the invention;

FIG. 17 is a side view of the variable rate friction damper of FIG. 16;

FIG. 17A is a section view of the variable rate friction damper of FIG. 16 taken along line 17A-17A in FIG. 17;

FIG. 18 is a side view of the variable rate friction damper of FIG. 16;

FIG. 18B is a section view of the variable rate friction damper of FIG. 16 taken along line 18B-18B in FIG. 18;

FIG. 18E is a detail view of the variable rate friction damper of FIG. 16 taken generally along line 18E-18E in FIG. 18B;

FIG. 19 is a front view of the variable rate friction damper of FIG. 16;

FIG. 19D is a section view of the variable rate friction damper of FIG. 16 taken along line 19D-19D in FIG. 19;

FIG. 20 is a side view of a spring clip for the variable rate friction damper of FIG. 16;

FIG. 21 is a front view of the spring clip of FIG. 20;

FIG. 22 is a front view of a housing for the variable rate friction damper of FIG. 16;

FIG. 22F is a section view of the housing of FIG. 22 taken along line 22F-22F in FIG. 22;

FIG. 23 is a back view of the housing of FIG. 22;

FIG. 24 is a side view of a rotor for the variable rate friction damper of FIG. 16;

FIG. 25 is a back view of the rotor of FIG. 24;

FIG. 26 is a front view of the rotor of FIG. 24;

FIG. 26A-1 is a section view of a slightly modified version of the variable rate friction damper of FIGS. 16-26, showing the damper in a “handle open” position;

FIG. 26A-2 is a section view of a slightly modified version of the variable rate friction damper of FIGS. 16-26, showing the damper in a “handle closed” position;

FIG. 26A-3 is a torque angle graph that corresponds to the varied degrees of rotation of the variable rate friction damper of FIGS. 16-26;

FIG. 26B-1 is a section view of another slightly modified version of the variable rate friction damper of FIGS. 16-26 showing the damper in a “handle open” position;

FIG. 26B-2 is a section view of another slightly modified version of the variable rate friction damper of FIGS. 16-26 showing the damper in a “handle closed” position;

FIG. 27 is a perspective view of a grab handle including one embodiment of a variable rate friction damper in accordance with the invention showing the grab handle in a retracted position;

FIG. 27A is another perspective view of the grab handle of FIG. 27 showing the grab handle in an extended position;

FIG. 28 is a top view of the grab handle of FIG. 27;

FIG. 29 is a front view of the grab handle of FIG. 27 showing the variable rate friction damper;

FIG. 30 is a perspective view of the variable rate friction damper of FIG. 27;

FIG. 31 is a front view of the variable rate friction damper of FIG. 27 showing a spring clip in a reduced resistance position;

FIG. 31A is section view of the variable rate friction damper of FIG. 27 taken along line 31A-31A in FIG. 31 showing the spring clip in an reduced resistance position;

FIG. 32 is another front view of the variable rate friction damper of FIG. 27 showing the spring clip in an increased resistance position;

FIG. 32B is section view of the variable rate friction damper of FIG. 27 taken along line 32B-32B in FIG. 32 showing the spring clip in an increased resistance position;

FIG. 33 is a top view of the variable rate friction damper of FIG. 27 showing the spring clip in an increased resistance position;

FIG. 34 is a top view of the variable rate friction damper of FIG. 27 showing the spring clip in a reduced resistance position;

FIG. 35 is a side view of a base for the variable rate friction damper of FIG. 27;

FIG. 35D is a section view of the base for the variable rate friction damper of FIG. 27, taken along the line 35D-35D in FIG. 35;

FIG. 36 is a front view of the base for the variable rate friction damper of FIG. 27;

FIG. 37 is a side view of a spring clip for the variable rate friction damper of FIG. 27;

FIG. 38 is a top view of a spring clip for the variable rate friction damper of FIG. 27;

FIG. 39 is a front view of a spring clip for the variable rate friction damper of FIG. 27;

FIG. 40 is a side view of a rotor for the variable rate friction damper of FIG. 27;

FIG. 41 is a top view of a rotor for the variable rate friction damper of FIG. 27;

FIG. 42 is a front view of a rotor for the variable rate friction damper of FIG. 27;

FIG. 43 is a side view of one embodiment of a variable rate friction damper in accordance with the invention;

FIG. 44 is a front view of the variable rate friction damper of FIG. 43;

FIG. 45 is a section view of the variable rate friction damper of FIG. 43 taken along line 45-45 in FIG. 43;

FIG. 46 is a detail section view of the variable rate friction damper of FIG. 43 taken along line 46-46 in FIG. 45;

FIG. 47 is a side view of one embodiment of a variable rate friction damper in accordance with the invention;

FIG. 48 is a front view of the variable rate friction damper of FIG. 47;

FIG. 49 is a section view of the variable rate friction damper of FIG. 47 taken along line 49-49 in FIG. 47;

FIG. 50 is a detail section view of the variable rate friction damper of FIG. 47 taken along line 50-50 in FIG. 49;

FIG. 51 is a side view of one embodiment of a variable rate friction damper in accordance with the invention;

FIG. 52 is a front view of the variable rate friction damper of FIG. 51;

FIG. 53 is a section view of the variable rate friction damper of FIG. 51 taken along line 53-53 in FIG. 51;

FIG. 54 is a section view of the variable rate friction damper of FIG. 51 taken along line 54-54 in FIG. 52;

FIG. 55 is a detail section view of the variable rate friction damper of FIG. 51 taken along line 55-55 in FIG. 51;

FIG. 56 is an exploded perspective view of one embodiment of a variable rate friction damper in accordance with the invention;

FIG. 57 is a perspective view of the variable rate friction damper of FIG. 56;

FIG. 58 is a side view of the variable rate friction damper of FIG. 56;

FIG. 59 is a front view of the variable rate friction damper of FIG. 56;

FIG. 60 is a back view of the variable rate friction damper of FIG. 56;

FIG. 61 is a side view of a housing for the variable rate friction damper of FIG. 56;

FIG. 62 is a section view of the housing of FIG. 61 taken along line 62-62 in FIG. 62;

FIG. 63 is a side view of a spring clip for the variable rate friction damper of FIG. 56;

FIG. 64 is a front view of the spring clip of FIG. 63;

FIG. 65 is a side view of a rotor for the variable rate friction damper of FIG. 56;

FIG. 66 is a front view of the rotor of FIG. 65;

FIG. 67 is a side view of one embodiment of a variable rate friction damper in accordance with the invention showing a rotor in a constant torque position;

FIG. 67A is a section view of the variable rate friction damper of FIG. 67 taken along line A-A in FIG. 67 showing a rotor in a constant torque position;

FIG. 68 is a front view of the variable rate friction damper of FIG. 67 showing a rotor in a constant torque position;

FIG. 69 is a detail view of the variable rate friction damper of FIG. 67 taken along line E-E in FIG. 67A;

FIG. 70 is a side view of the variable rate friction damper of FIG. 67 showing a rotor in a brake torque start position;

FIG. 70B is a section view of the variable rate friction damper of FIG. 67 taken along line B-B in FIG. 70 showing a rotor in a brake torque start position;

FIG. 71 is a front view of the variable rate friction damper of FIG. 67 showing a rotor in a brake torque start position;

FIG. 72 is a detail view of the variable rate friction damper of FIG. 67 taken along line F-F in FIG. 70B showing a rotor in a brake torque start position;

FIG. 73 is a side view of the variable rate friction damper of FIG. 67 showing a rotor in a peak brake torque position;

FIG. 73C is a section view of the variable rate friction damper of FIG. 67 taken along line C-C in FIG. 73 showing a rotor a peak brake torque position;

FIG. 74 is a front view of the variable rate friction damper of FIG. 67 showing a rotor in a peak brake torque position;

FIG. 75 is a detail view of the variable rate friction damper of FIG. 67 taken along line G-G in FIG. 73C showing a rotor in a peak brake torque position;

FIG. 76 is an exploded perspective view of one embodiment of a variable rate friction damper in accordance with the invention;

FIG. 77 is a front view of the variable rate friction damper of FIG. 76;

FIG. 78 is a back view of the variable rate friction damper of FIG. 76;

FIG. 79 is a side view of the variable rate friction damper of FIG. 76;

FIG. 79A is a section view of the variable rate friction damper of FIG. 76 taken along line A-A in FIG. 79;

FIG. 80 is a perspective view of one embodiment of a variable rate friction damper in accordance with the invention;

FIG. 81 is a top view of the variable rate friction damper of FIG. 80;

FIG. 82 is a front view of the variable rate friction damper of FIG. 80;

FIG. 82A is a section view of the variable rate friction damper of FIG. 80 taken along line A-A in FIG. 82;

FIG. 83 is a perspective view of a grab handle including the variable rate friction damper of FIG. 80 showing the grab handle in a retracted position; and

FIG. 84 is another perspective view of the grab handle of FIG. 83 showing the grab handle in an extended position.

### DETAILED DESCRIPTION

Several embodiments of the invention are shown herein as examples of variable rate friction dampers in accordance with the invention that vary the damping torque in order to control rotational motion. In each embodiment, the torque is varied by changing the level of interference of some components of the dampers depending on the angular position of the damper. The invention disclosed herein is generally made of a combination of plastic and metal which are selected for certain components based on the friction generated when the components slide against each other. Some non-limiting examples of plastic materials that may be used are Acetal, Nylon, PP, PBT, HDPE, Polycarbonate. Of course such materials may also include additives that may alter frictional, wear, or mechanical properties of the materials. Many of the embodiments herein include a metal spring component that may be made of spring steel, stainless steel, or any other suitable metal without departing from the invention.

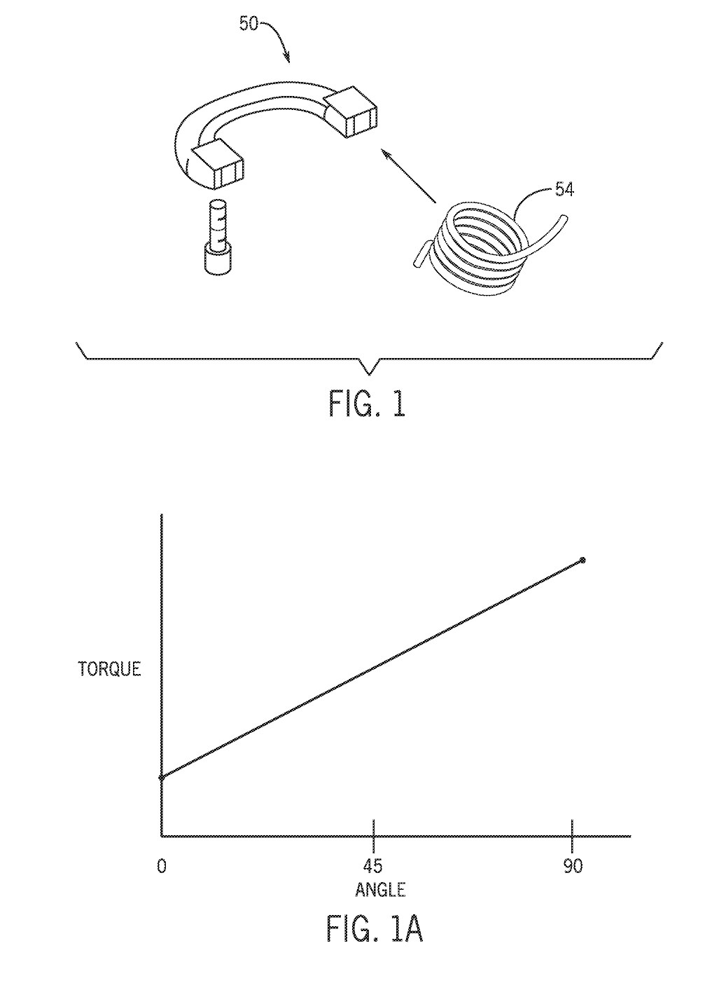

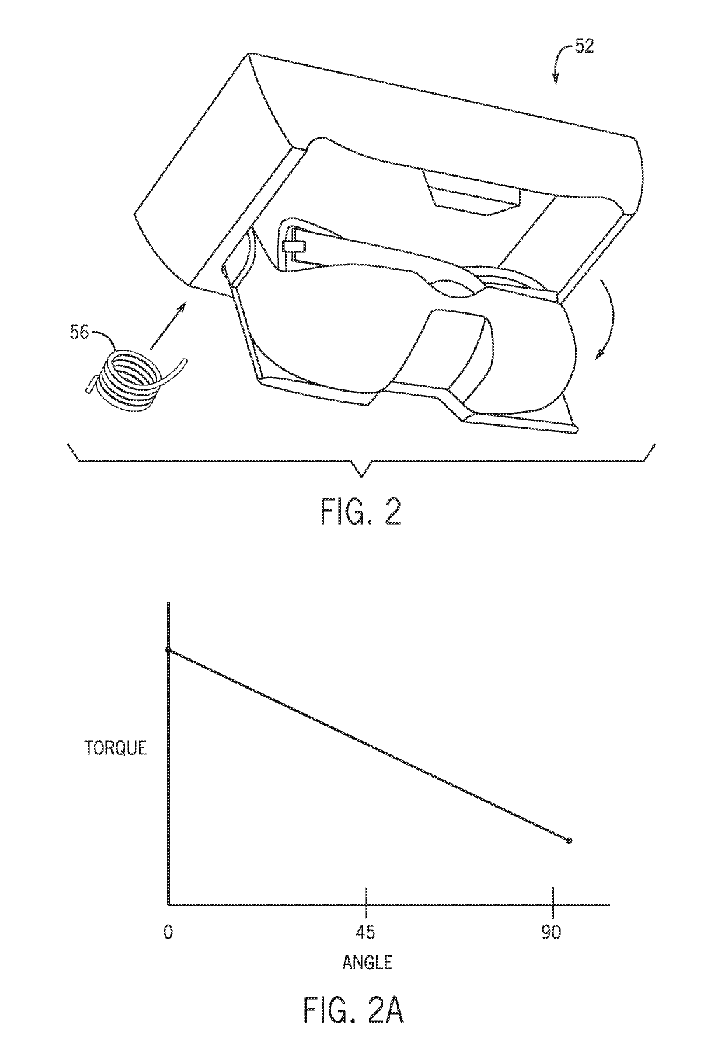

FIGS. 1-2 show how torsion springs are used in vehicle grab handles 50 and a vehicle drop down compartment 52. FIG. 1 shows an example of a vehicle grab handle 50 that includes a torsion spring 54. FIG. 1A shows the torque curve of torsion spring 54. As the angle of rotation increases from zero degrees to 90 degrees, the torque generated by the torsion spring 54 increases in a linear manner.

FIG. 2 shows an example of a vehicle drop down compartment 52 that includes a torsion spring 56. When used in a drop down compartment, it is advantageous to use a torsion spring 56 that generates maximum torque when the angle of rotation of the drop down compartment is zero degrees and decreases in a linear manner as the angle of rotation increases to 90 degrees.

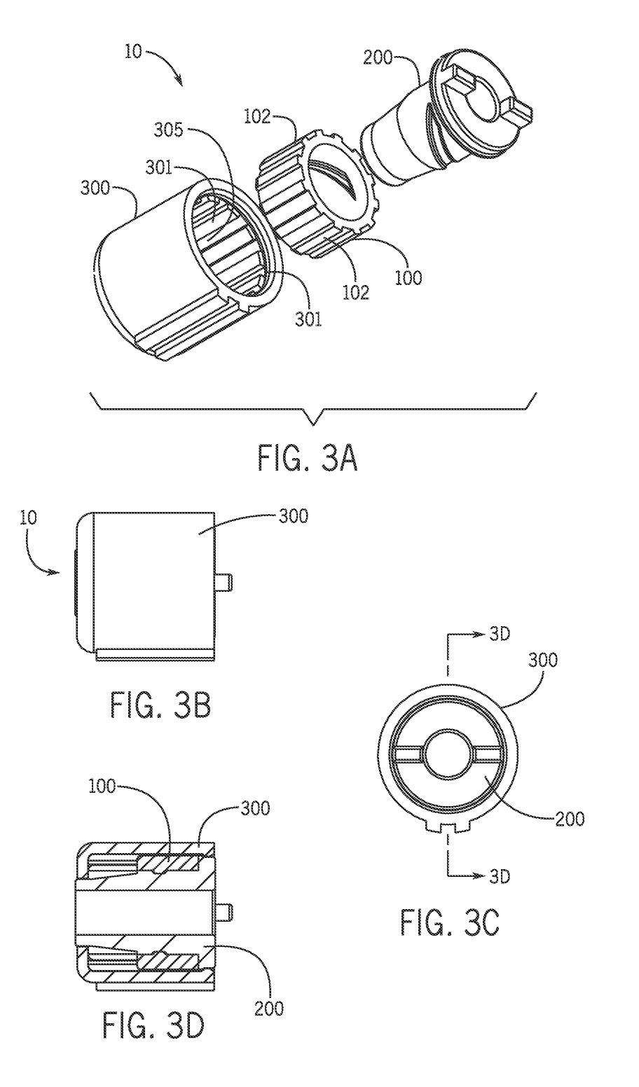

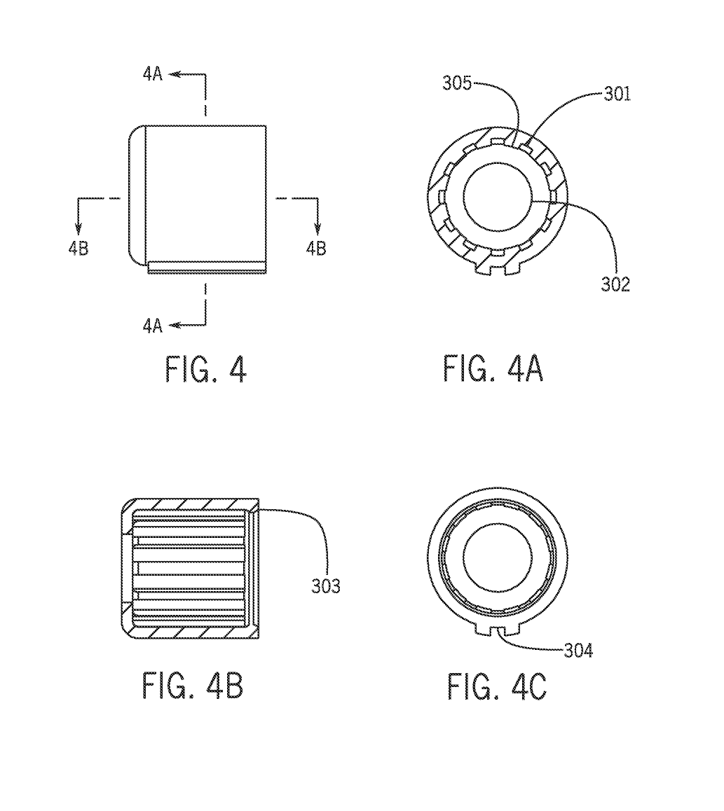

FIGS. 3-9 show one embodiment of a variable rate friction damper 10 in accordance with the invention. Variable rate friction damper 10 uses a ‘barrel’ or cylindrical type interference for rotary damping. Variable rate friction damper 10 includes a cover 300 into which a sleeve 100 and rotor 200 are inserted. Cover 300 includes a cover bore 305, which includes a plurality of spline grooves 301 disposed around the cover bore. Cover 300 further includes a cover hole 302 which allows the damper 10 to be connected to the thing being dampened and cover ring 303, which engages rotor lip 208 to retain the rotor 200 inside the cover 300, but still allowing the rotor to rotate. Sleeve 100 has a plurality of spline teeth 102, an outer diameter 103 and an inner diameter 104. When the variable rate friction damper 10 is assembled, the spline grooves 301 engage the spline teeth 102 to prevent the sleeve 100 from rotating inside the cover 300.

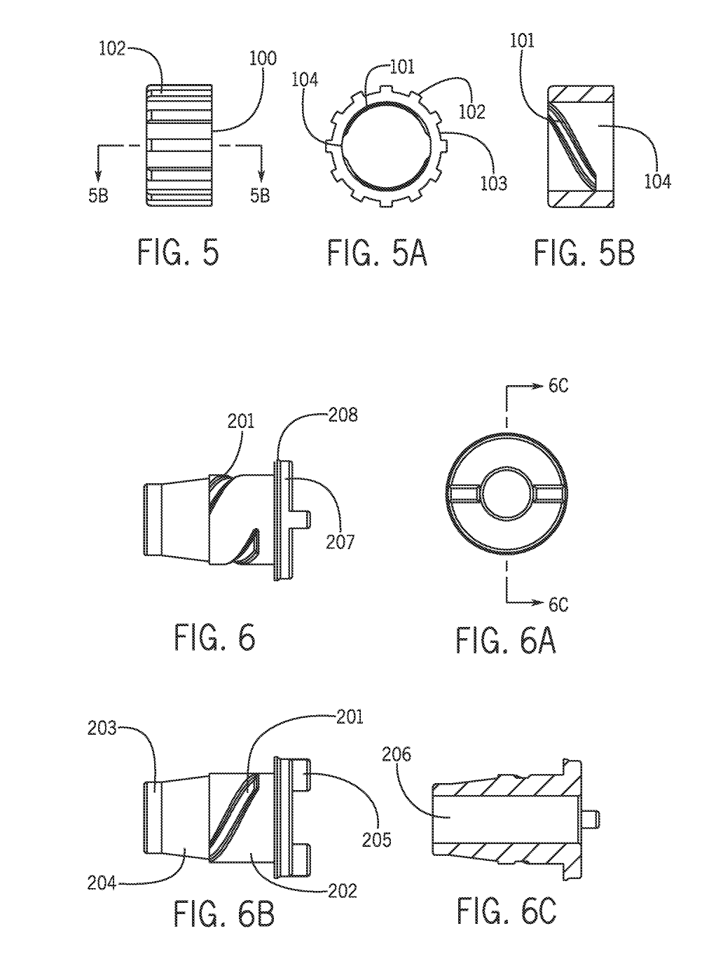

As shown in FIGS. 5-6, cylindrical interference is generated by forming a barrel groove 201 and/or rotor barrel 202 slightly greater in size than helical rib 101 and/or sleeve inner diameter 104 respectively. The amount of interference between the barrel groove 201 and/or rotator barrel 202 and the helical rib 101 can be adjusted by design to create the desired variable rate torque damping resistance.

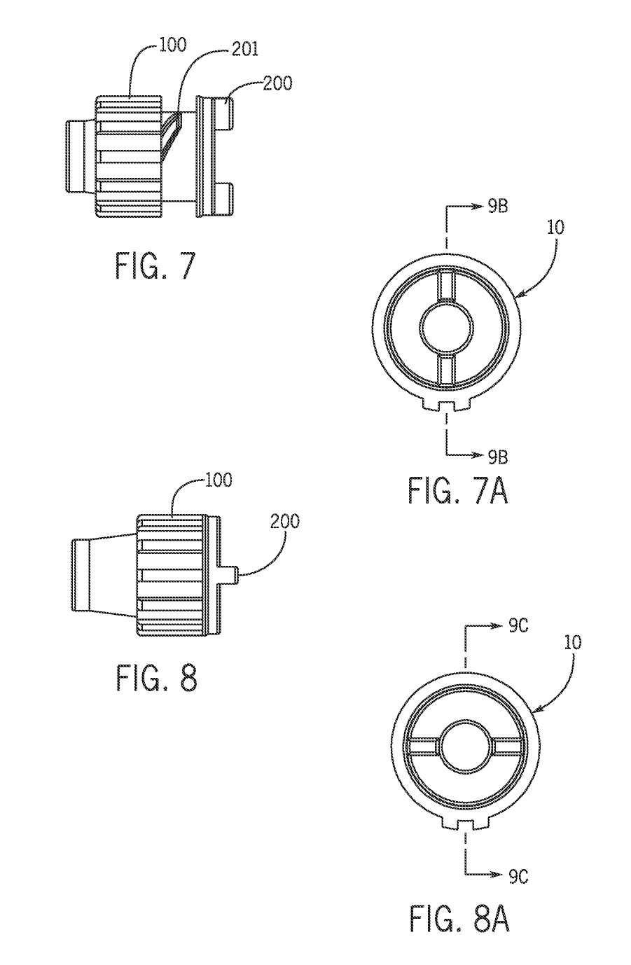

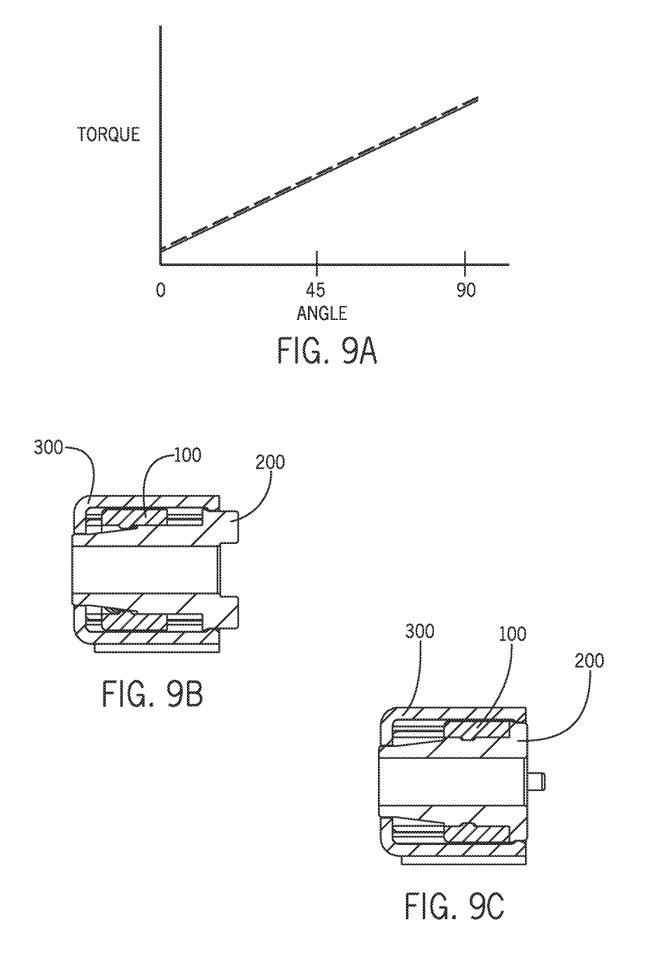

The interference is changed by using a helical rib 101 to change the length of engagement cylindrical interference as shown in FIGS. 7-9. As the helical rib 101 moves through the barrel groove 201 and/or rotor barrel 202, the damping torque increases due to the increased interference fit. FIG. 7 shows the sleeve 100 in a first position relative to the rotor 200, and FIG. 8 shoes the sleeve in a second position relative to the roller. FIG. 9A shows one example of a torque curve that may be achieved using the variable rate friction damper 10.

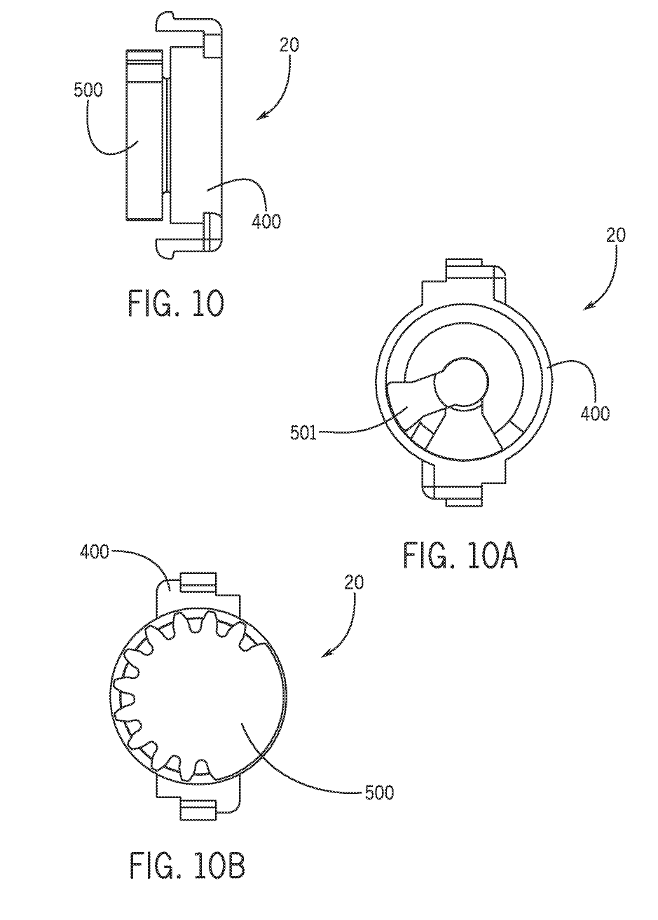

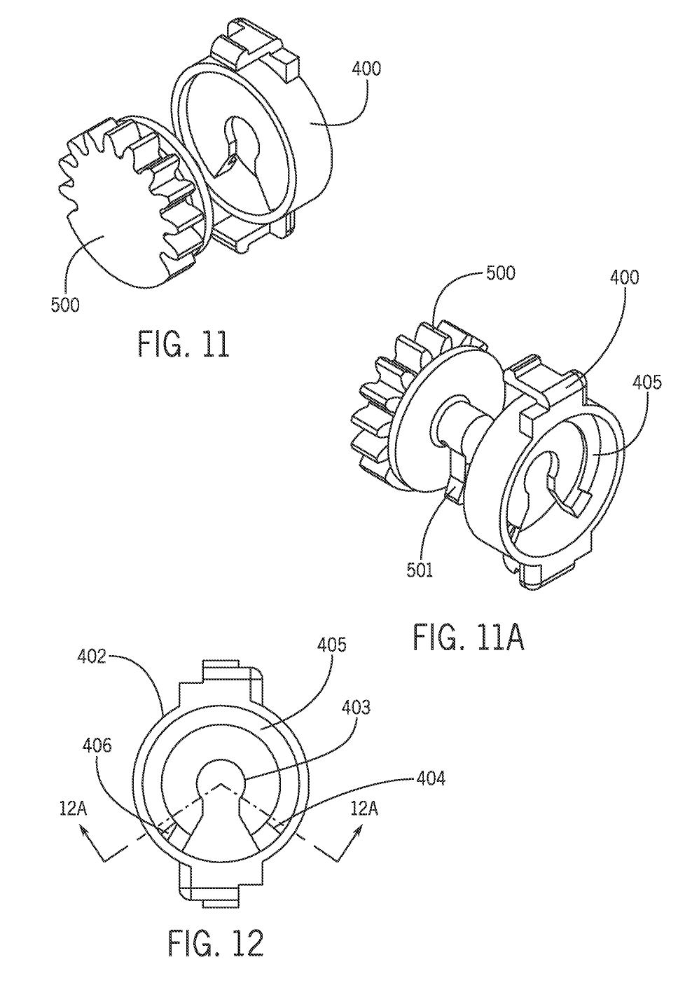

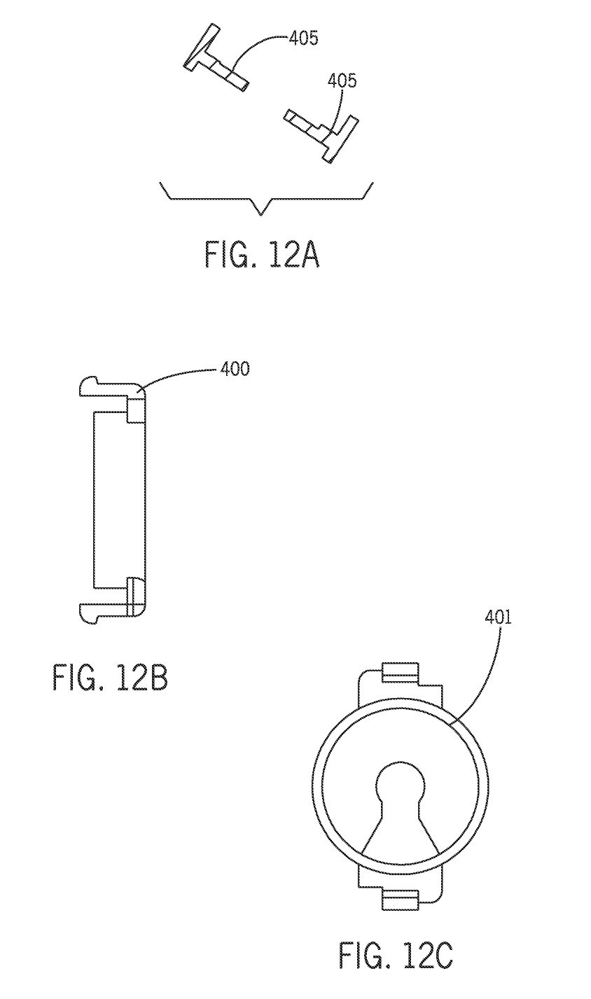

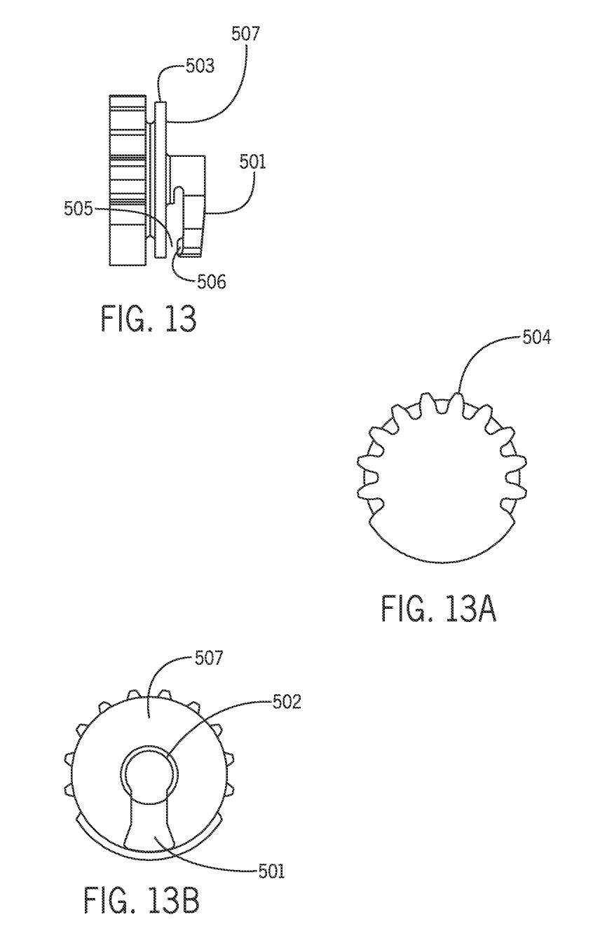

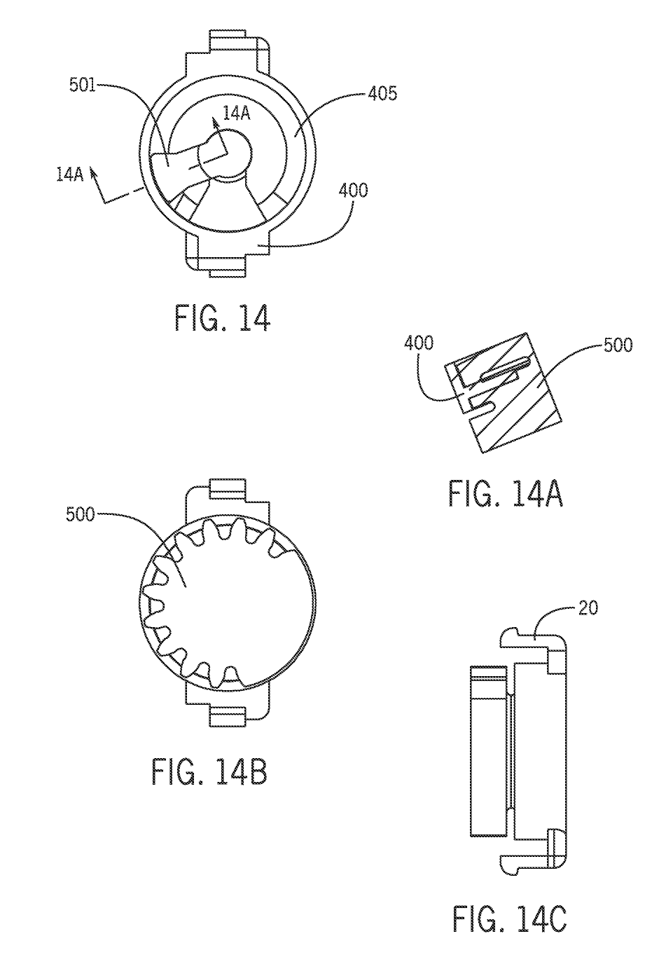

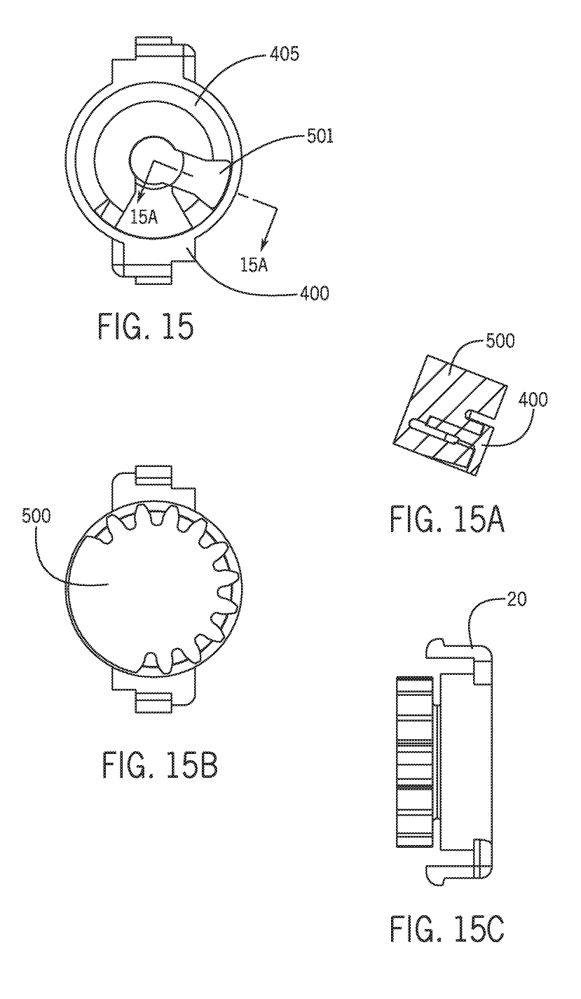

FIGS. 10-15 show another embodiment of a variable rate friction damper 20. Variable rate friction damper 20 relies on beam interference for rotary damping. As shown, this embodiment uses a housing 400 and a gear rotor 500 to achieve variable rate torque damping. A rotating beam 501, similar to a diving board, has a contact surface 506 that rides along a helical ramp 405. As the contact surface 506 rides along helical ramp 405, beam gap 505 increases or decreases depending on the thickness of helical ramp 405. The thickness of the helical ramp 405 as shown in FIG. 12A can increase or decrease to achieve the interference and desired damping at any angle of rotation. An increased beam gap 505 will increase interference and damping torque. A reduced beam gap 505 will reduce interference and damping torque. As with the previously described embodiment, a variable change in damping torque is simply and inexpensively achieved without the limitations and drawbacks of prior art viscous oil dampers or friction dampers. The thickness of the helical ramp 405 may not necessarily be continuously changing. It may be desirable to have a constant thickness for a given angular range then ramp up or down to a different thickness to achieve a desired motion or torque.

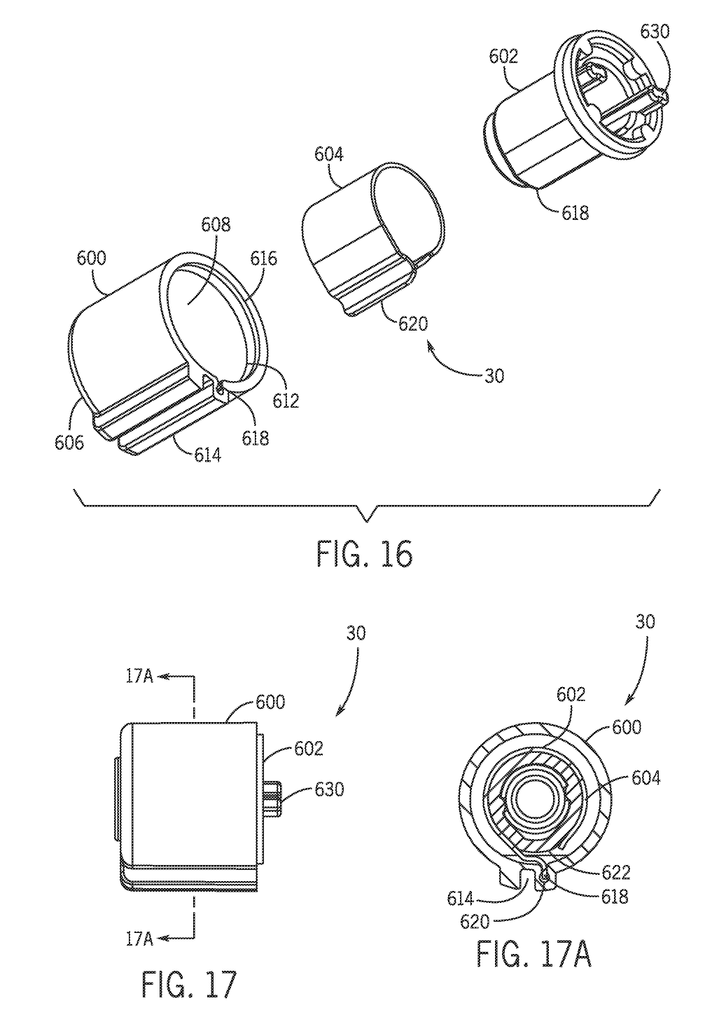

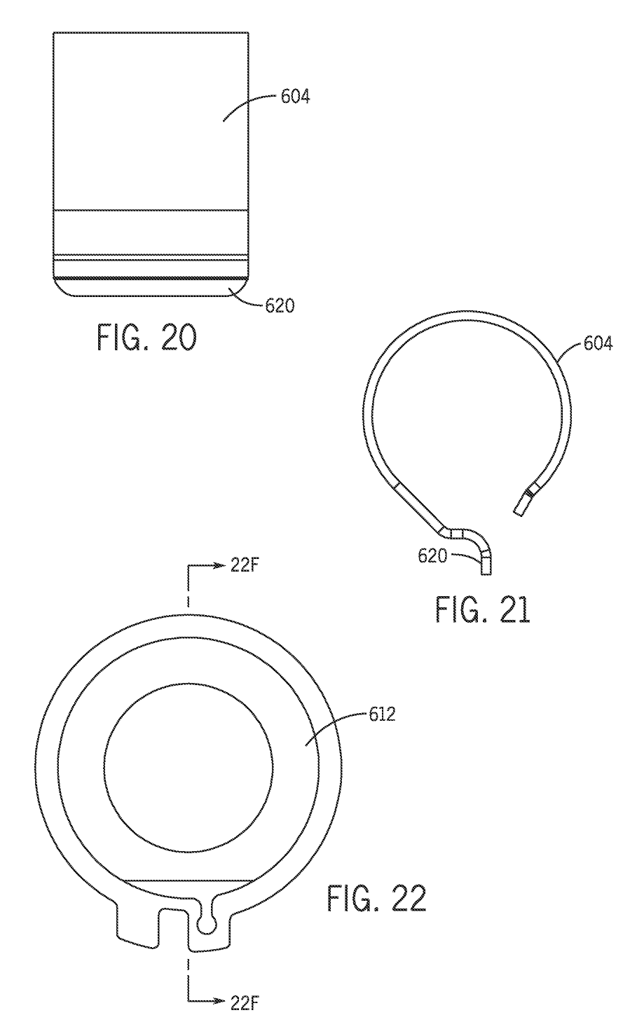

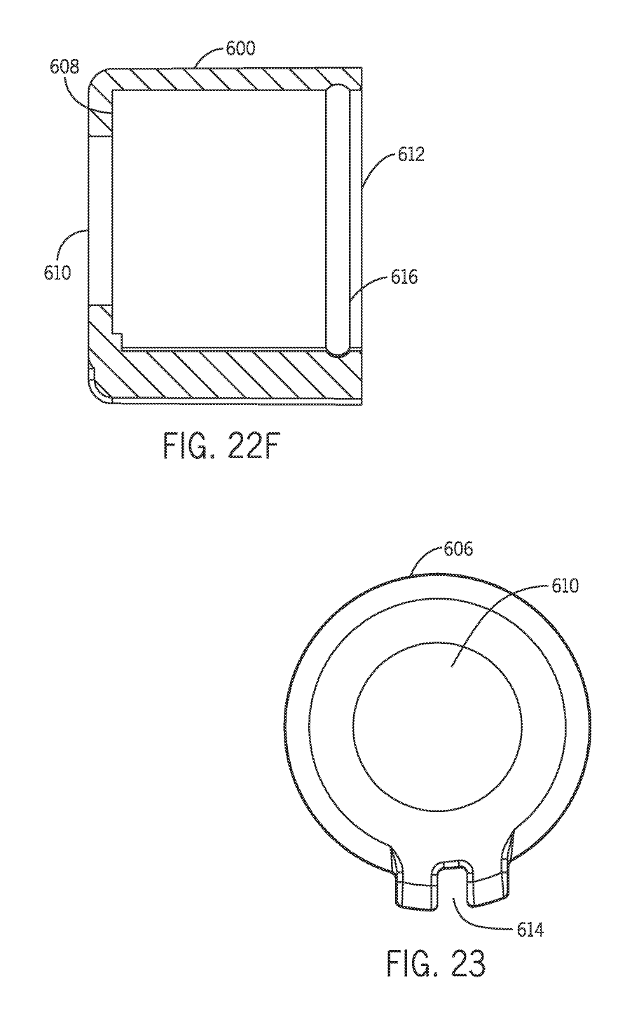

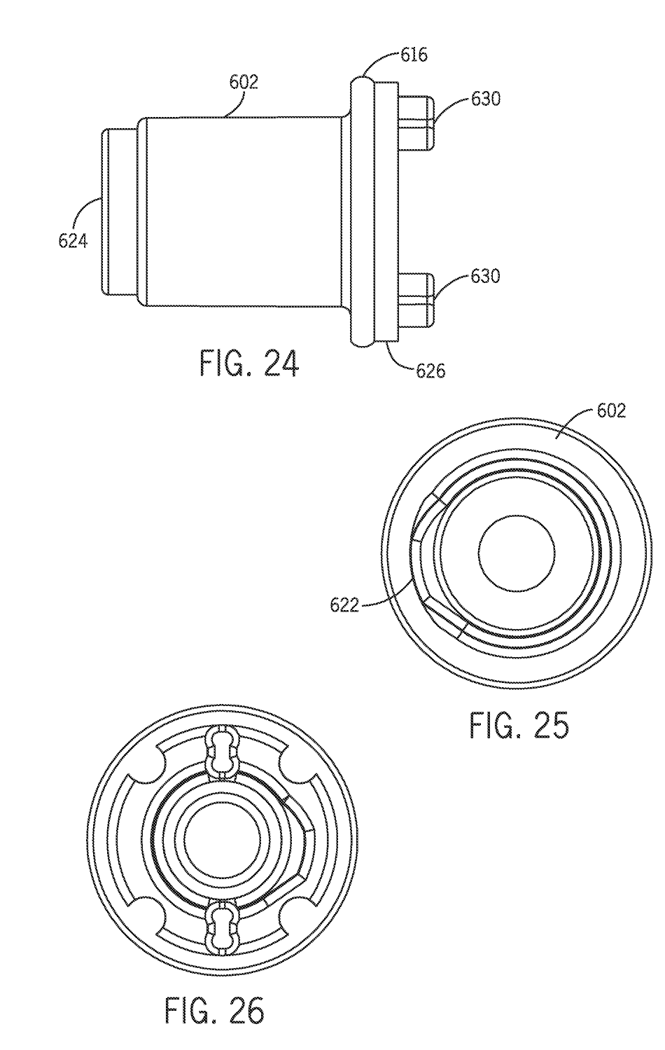

FIGS. 16-26 show another embodiment of a variable rate friction damper 30 in accordance with the invention. Variable rate friction damper 30 includes three components: a housing 600, a rotor 602, and a spring clip 604 preferably made from metal such as stainless steel or spring steel. When assembled, the rotor 602 engages spring clip 604 to varying degrees as the rotor rotates inside the variable rate friction damper 30. The ‘C’ shape portion of the spring clip 604 provides a gradual change in interference force when expanded by the rotor 602 by nature of its curved shape. This gradual change helps to reduce variation in interference force resulting from manufacturing tolerances of both the rotor 602 and spring clip 604. Using metal to produce spring clip 604 provides a consistent modulus of elasticity or “spring rate” over a desired range of temperatures and insignificant dimensional changes from thermal expansion or contraction. In the embodiment shown, the housing 600 has a generally cylindrical shape including an exterior surface 606 and an interior cavity 608. The housing 600 further includes an end bore 610 and a head bore 612 at either end of the housing.

As shown, the housing 600 further includes a holding slot 614 that is integrally formed on the exterior surface 606. The holding slot 614 allows the variable rate friction damper 30 to be anchored to a base so that the housing 600 remains stationary during operation of the damper. In the embodiment shown, the holding slot 614 is generally rectangular in cross-section, but any suitable shape may be used without departing from the invention. The housing further includes a bearing channel 616 located near the head bore 612.

A spring clip retention slot 618 is integrally formed into the housing 600. The spring clip 604 includes a retention flange 620 that is inserted into the retention slot 618 and is retained therein during operation of the variable rate friction damper 30. The spring clip 604 has a generally cylindrical shape portion that fits inside the interior cavity 608. The spring clip 604 does not contact the interior cavity 608.

The rotor 602 has a generally cylindrical shape with a contact lobe 622, a first end 624, a second end 626, and a bearing surface 628. The first end 624 fits into the end bore 610 and centers the rotor inside the housing 600. The bearing surface 628 engages the bearing channel 616 and rotatably secures the rotor 602 to the housing 600. In the embodiment shown, the housing 600 is made of a material that may deform slightly to allow the rotor 602 to be inserted into the housing so that the bearing surface 628 engages the bearing channel 616. After the rotor 602 is inserted into the housing 600, it is retained in the housing by the engagement of the bearing channel 616 and the bearing surface 628. The spring clip 604 is disposed between the rotor 602 and the housing 600, and is installed prior to the insertion of the rotor into the housing. A mandrel may be used to expand and assemble the spring clip 604 on to the rotor 602 and achieve the desired interference. The rotor 602 also includes at least one drive lug 630 that engage the item to be damped.

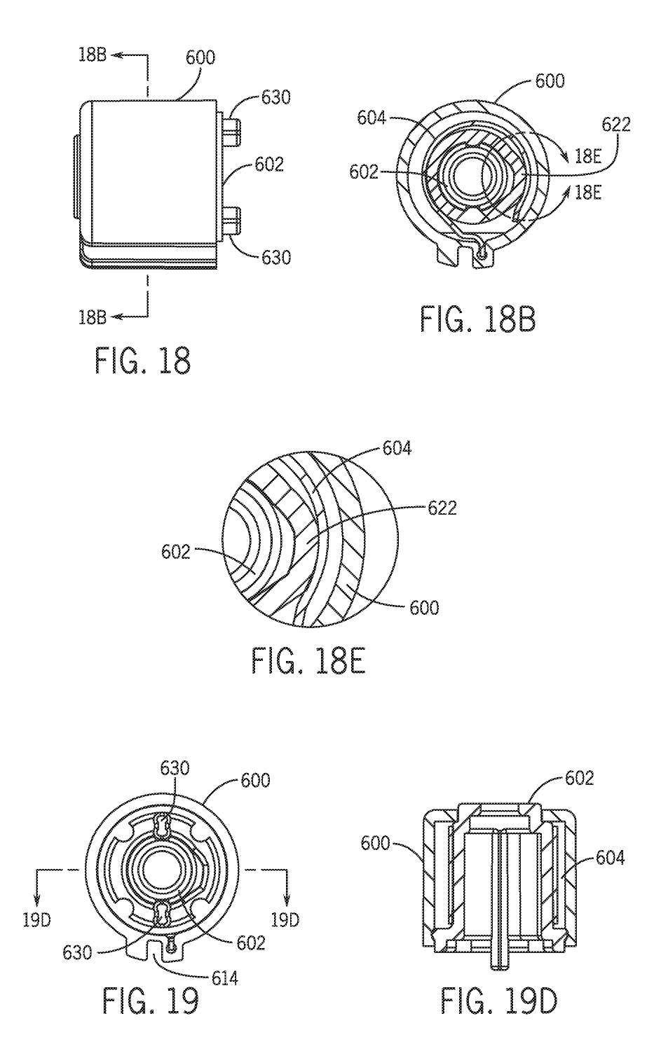

As shown in FIGS. 17A, 18B, and 18E, the contact lobe 622 may be oriented so that it does not expand the spring clip 604, and may be rotated into a position that causes the spring clip to expand. As rotor 602 rotates, contact lobe 622 expands or contracts the spring clip 604, which in turn causes an increase or decrease in the spring force exerted onto the contact lobe, resulting in the desired damping at any angle of rotation. An increased angle of rotation will increase the amount of expansion of the spring clip 604 and damping torque. Reducing the angle of rotation also reduces the amount of expansion of the spring clip 604, which reduces the damping torque. As with the previously described embodiments, a variable change in damping torque is simply and inexpensively achieved without the limitations and drawbacks of prior art viscous oil dampers or friction dampers.

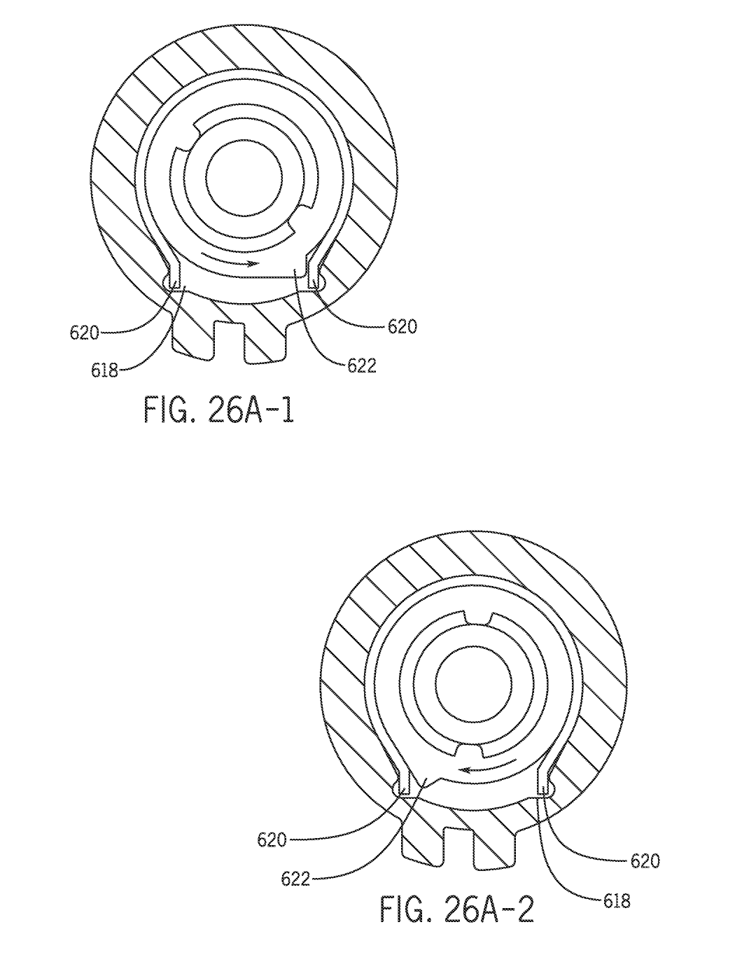

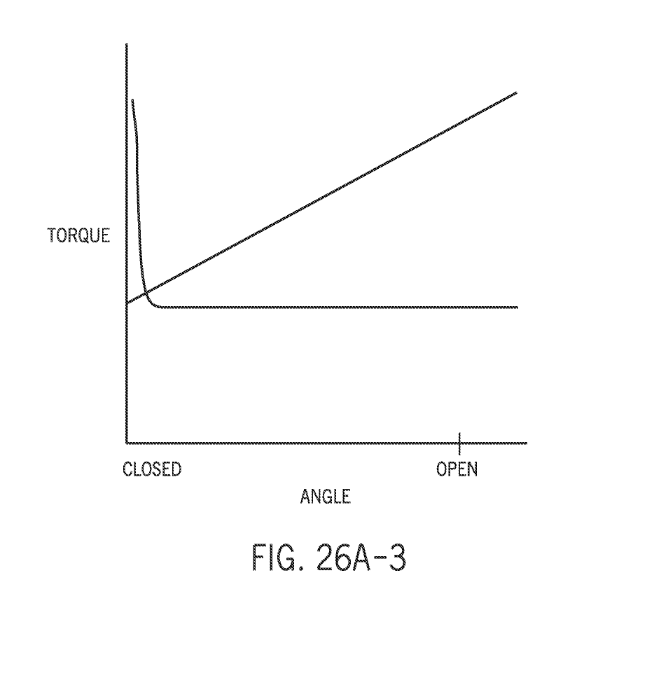

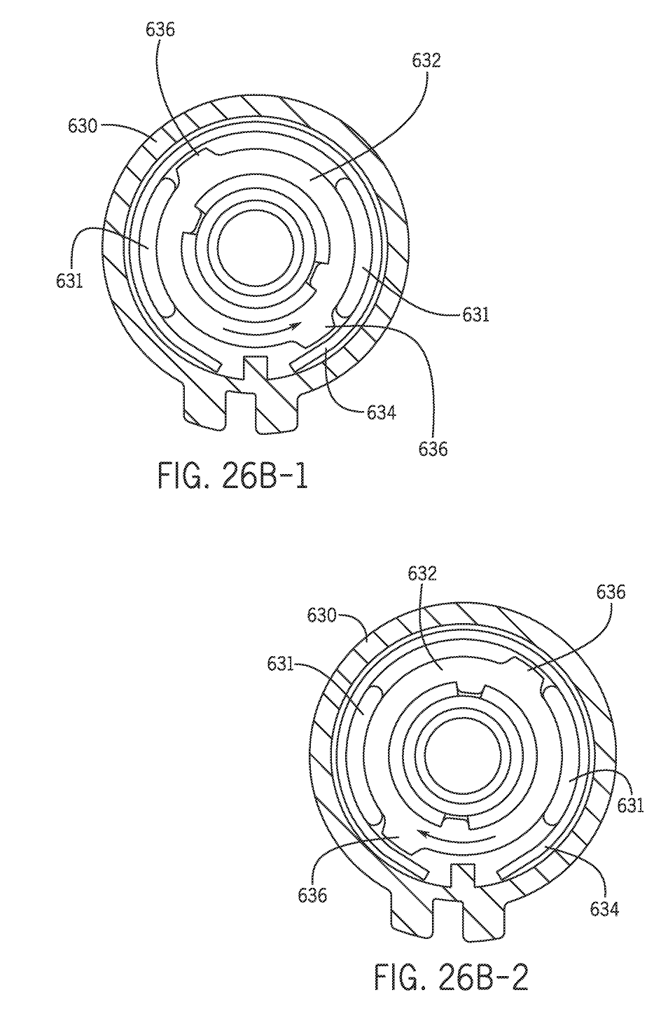

FIGS. 26A-1 and 26A-2 show slightly modified versions of the variable rate friction damper 30 showing the damper in a “handle open” and a “handle closed” position. In this version, the spring clip is simplified and made symmetric with a retention flange 620 at both ends. The spring clip retention slot 618 is widened to hold both retention flange ends 620. The rotor shape shown has a constant torque until the very end of rotation where it increases rapidly to “brake” the motion of the handle just prior to closing using a single wedge shaped lobe 622 cam face. This helps prevent any closing noise from the handle hitting its final stop. FIG. 26A-3 shows a torque angle graph that corresponds to the varied degrees of rotation and reflecting the significant increase in torque created by the cam face at the end of the rotation.

FIG. 26B shows a cross-section of a slightly modified version of the variable rate friction damper of FIG. 26A. In this version there are semicircular sections of material 631 extending from the inside of the housing 630 that run between the rotor 632 and clip 634 to provide plastic on plastic frictional contact. This version also shows a two lobe 636 wedge shape cam shape for the rotor. Any number or style of cam shapes could be used to achieve the variable damping resistance desired without departing from the invention.

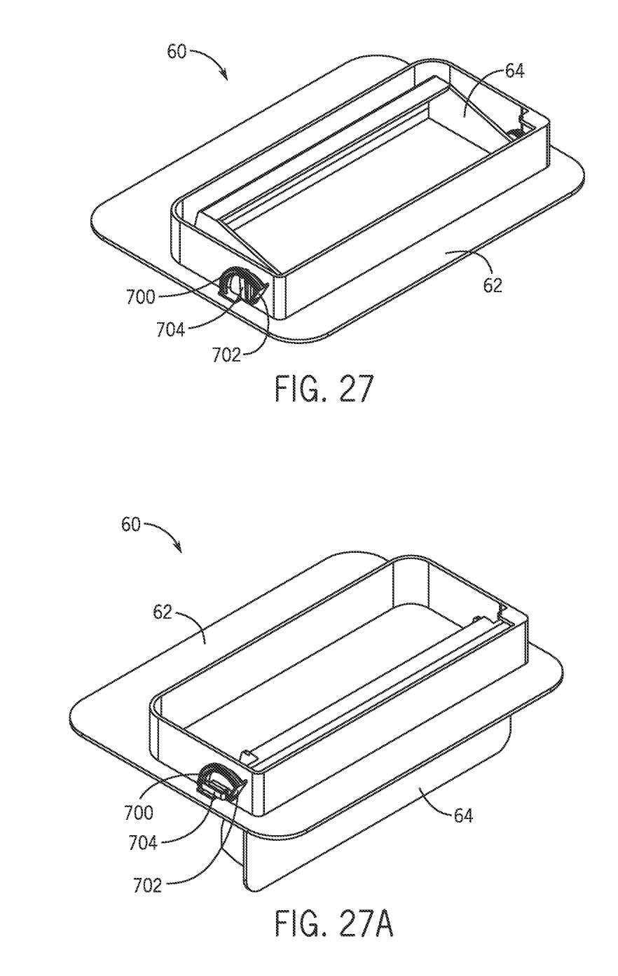

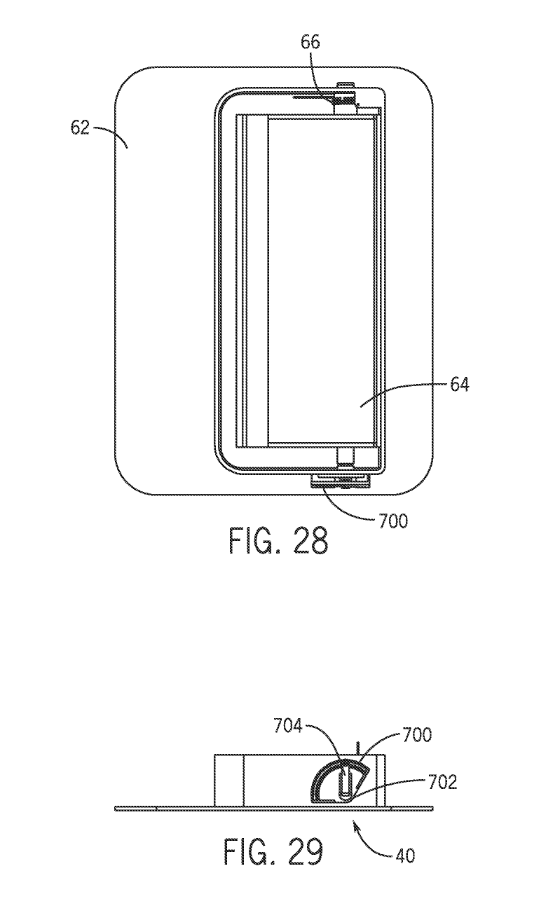

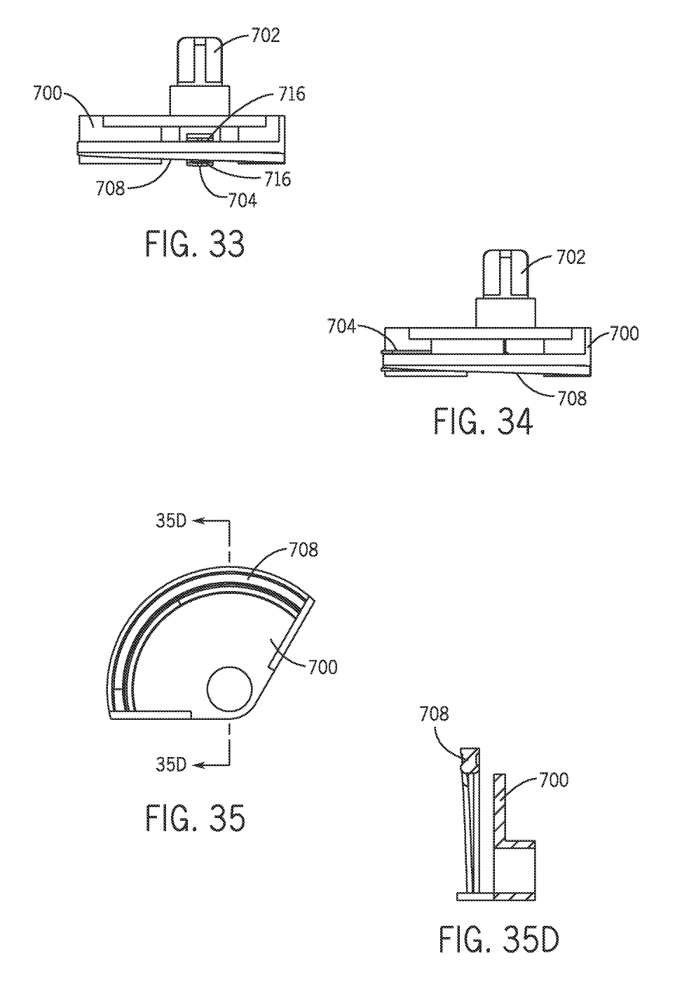

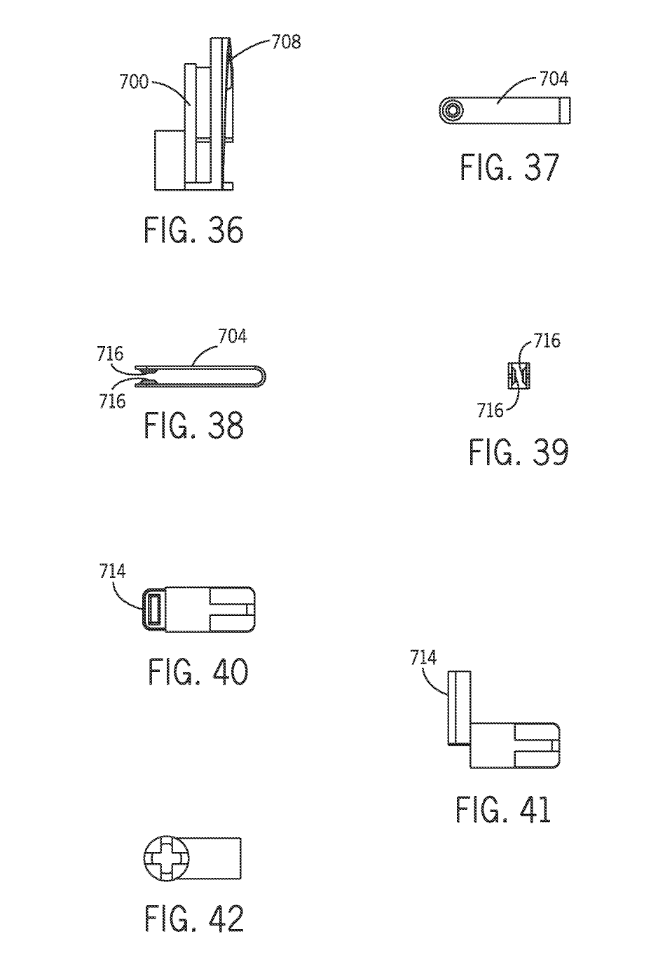

Turning now to FIGS. 27-42, another embodiment of a variable rate friction damper 40 in accordance with the invention is shown. As shown in FIGS. 27-29, the variable rate friction damper 40 may be used to dampen the motion of a compartment door 60. The compartment door 60 includes a base 62 and a door 64. The door 64 is biased toward a closed position by a torsion spring 66. The torsion spring 66, along with the variable rate friction damper 40 provide smooth, controlled operation of the door 64 so that it opens and closes in a way that is pleasing to the eye and to the touch of the user. When the door 64 is open, the variable rate friction damper 40 is in a reduced friction position, but when the user closes the door, the variable rate friction damper rotates to a gradually increasing friction position. The effect of the gradual increase in friction is perceived as constant resistance by the user because the spring force exerted by the torsion spring 66 decreases at a similar rate as the door 64 is closed.

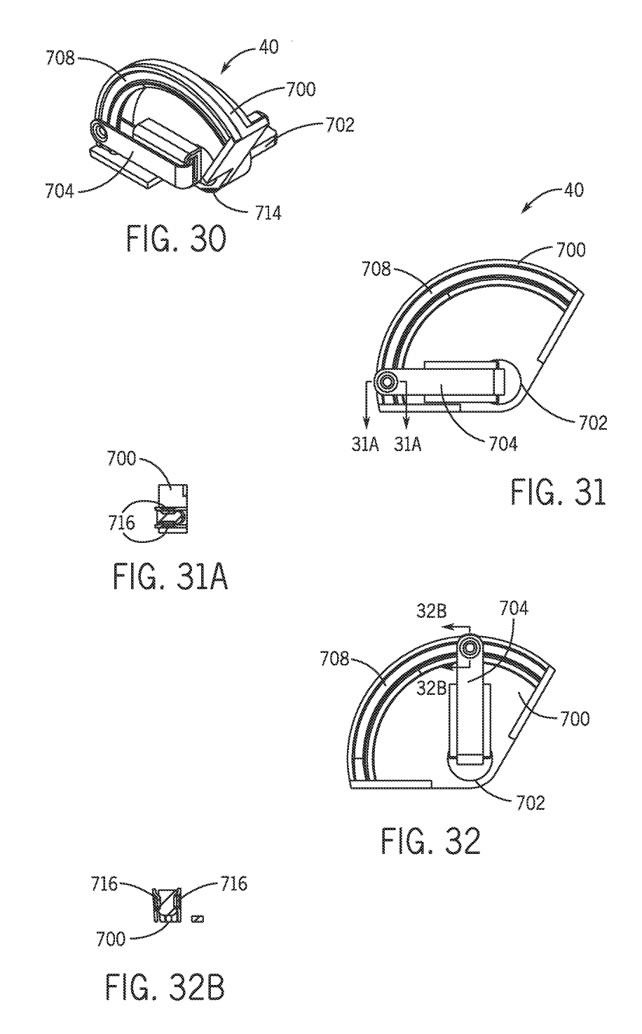

As shown in FIGS. 30-42, variable rate friction damper 40 includes a base 700, a rotor 702, and a spring clip 704. In the embodiment shown, the base 700 includes an arcuate portion 706 that has a ramped surface 708. The arcuate portion 706 has a first thickness at a first end 710, and a second thickness at a second end 712. The ramped surface 708 is disposed between the first and second ends and engages the spring clip 704 during operation of the variable rate friction damper 40.

In the embodiment shown, the spring clip 704 is generally U-shaped and is attached to the rotor 702 by inserting the spring clip through a clip holder 714. Of course, the spring clip 704 may have a different shape or connect to the rotor 702 by any other suitable means without departing from the invention. The spring clip further includes contact surfaces 716 opposite the bottom of the U-shape. The contact surfaces 716 are offset from each other and engage the ramped surface 708 when the variable rate friction damper 40 is in use. Rotation of the rotor 702 causes the spring clip 704 to rotate as well. As the spring clip 704 rotates, the contact surfaces 716 travel along the ramped surface 708, which causes the spring clip to expand or contract, which in turn causes an increase or decrease in the spring force exerted onto the ramped surface, resulting in the desired damping at any angle of rotation. An increased angle of rotation will increase the amount of expansion of the spring clip 704 and damping torque. Reducing the angle of rotation also reduces the amount of expansion of the spring clip 704, which reduces the damping torque. As with the previously described embodiments, a variable change in damping torque is simply and inexpensively achieved without the limitations and drawbacks of prior art viscous oil dampers or friction dampers.

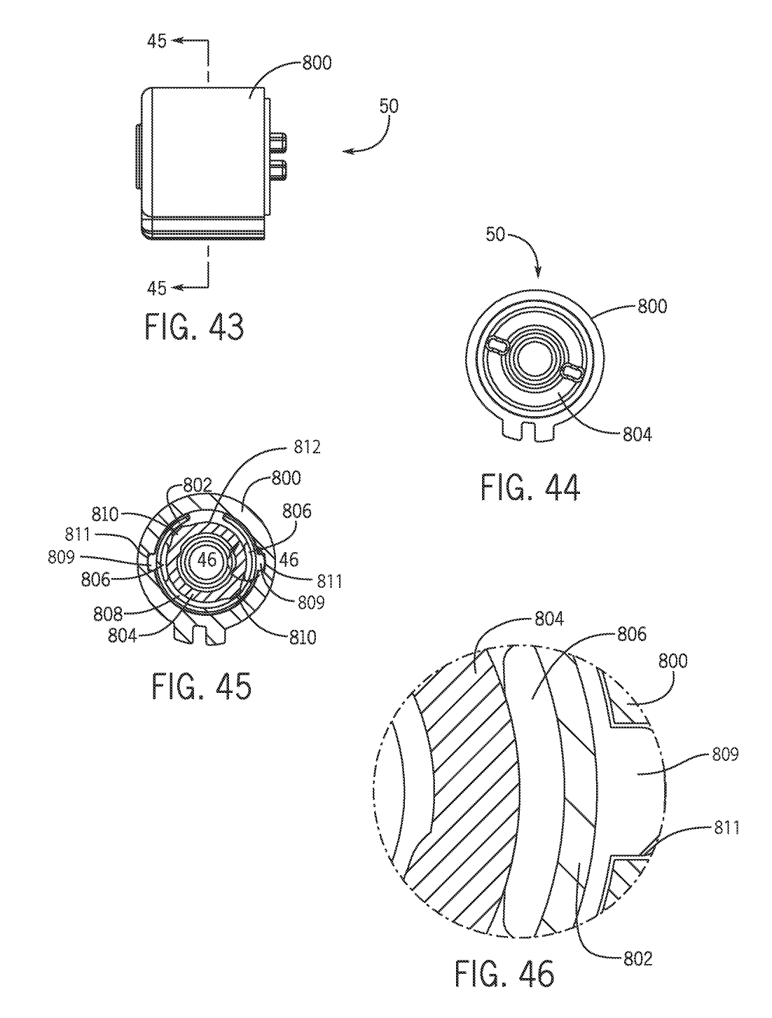

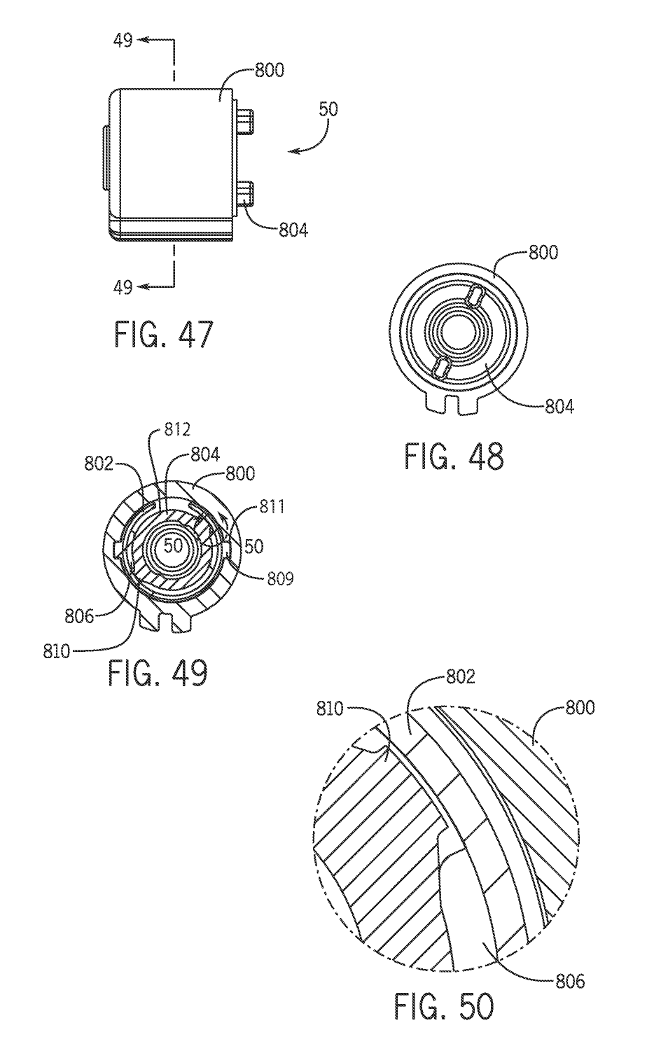

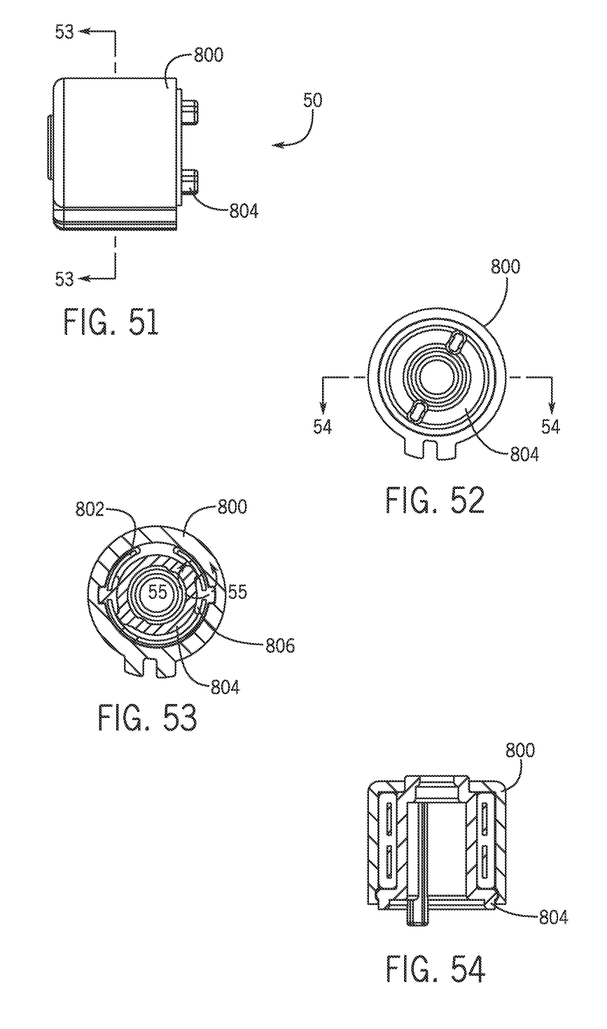

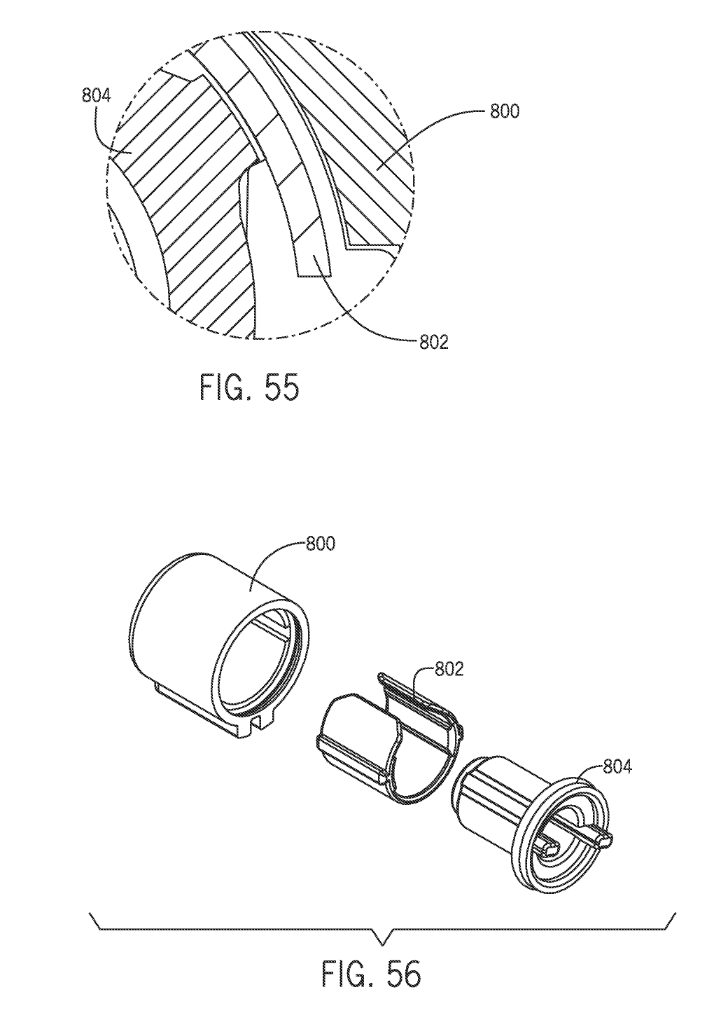

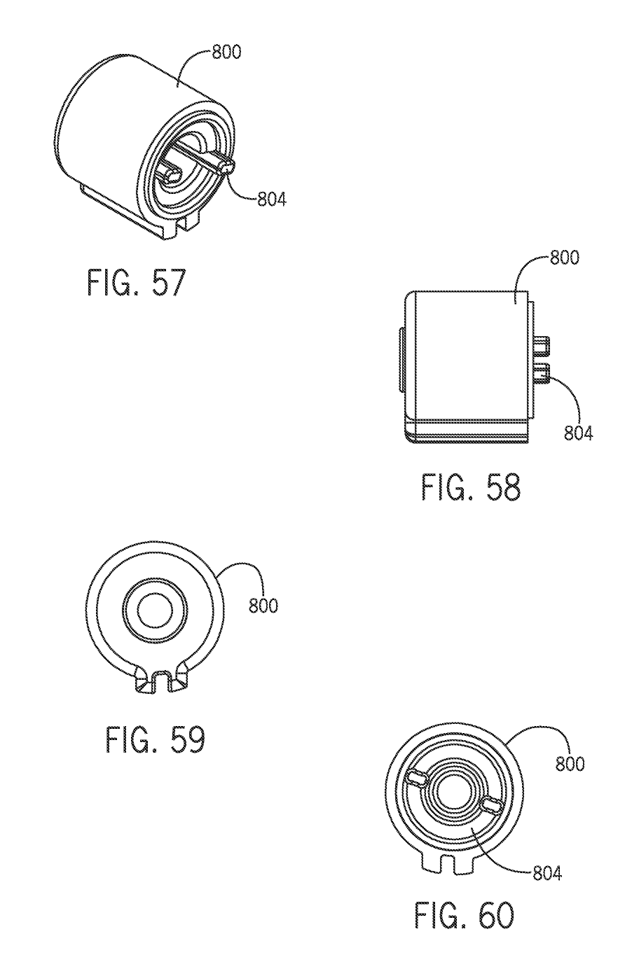

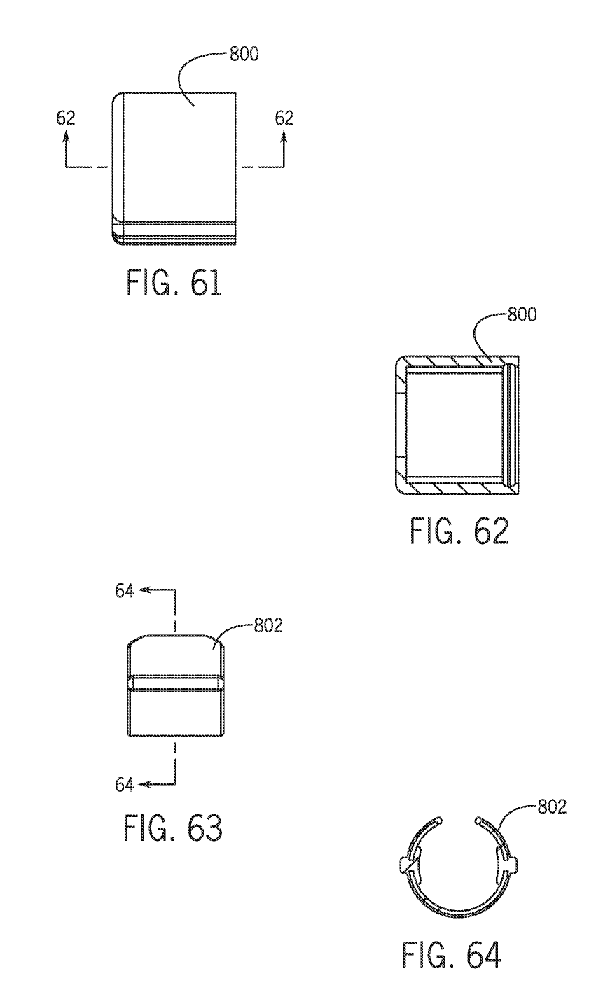

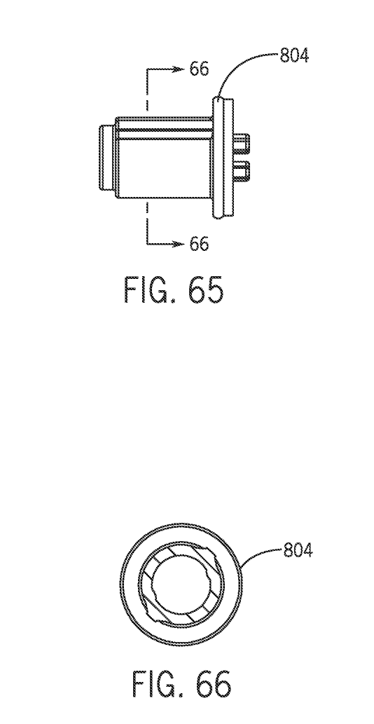

Turning now to FIGS. 43-66, various other embodiments of a variable rate friction damper 50 in accordance with the invention is shown. The embodiments shown operate similarly to the embodiment shown in 16-26, but with variations to the profile of the spring clip and/or rotor to achieve variations in dampening torque generation depending on the angle of rotation. Variable rate friction damper 50 may provide a damping torque rate that has a constant torque over a prescribed angular range and then rapidly increasing along the final few degrees of rotation, resulting in a damper having a braking effect. As in some of the previously described embodiments, variable rate friction damper 50 includes a housing 800, a spring clip 802, and a rotor 804. However, unlike the previous embodiments, the spring clip 802 further includes over-molded plastic brake portions 806 that protrude from the inside surface 808 of the spring clip as well as retention tabs 809 on the outside surface of spring clip 802. This arrangement provides plastic on plastic contact between sliding surfaces, which has preferred friction characteristics. The retention tabs 809 fit within retention slots 811 on the inside of housing 800 and prevent clip 802 from rotating with rotor 804. Rotor 804 includes an outside surface 812 that includes brake lobes 810 and contacts the inside of brake portions 806. As the rotor 804 rotates brake lobes 810 cause spring clip 802 to expand, thereby increasing the dampening torque. When rotor 804 rotates to a position where brake lobes 810 contact brake portions 806, spring clip 802 is forced to expand more than when just outside surface 812 is in contact with the brake portions 806. This additional rapid expansion rapidly increases the dampening torque generated by the spring clip 802, which results in a braking effect. The embodiment shown shows only brake portions 806 and retention tabs 809, but a single or any number of protrusions may be used to provide varying dampening torque as desired.

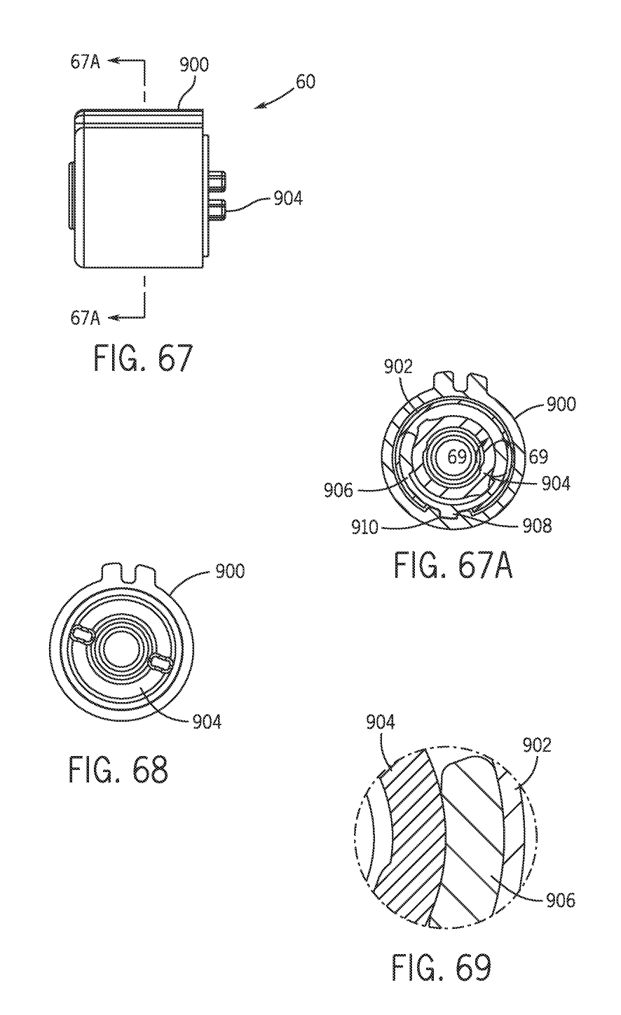

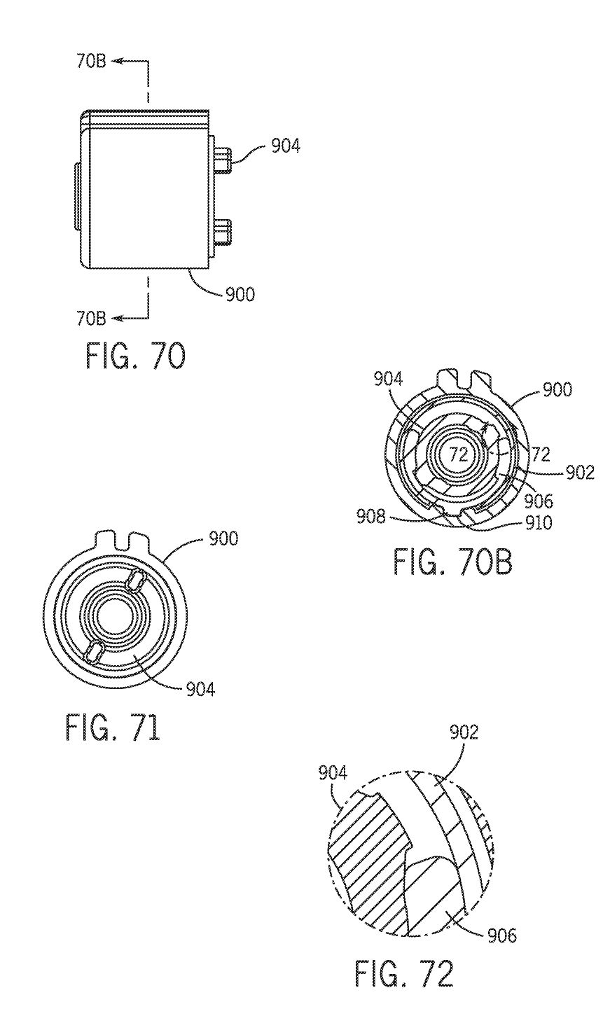

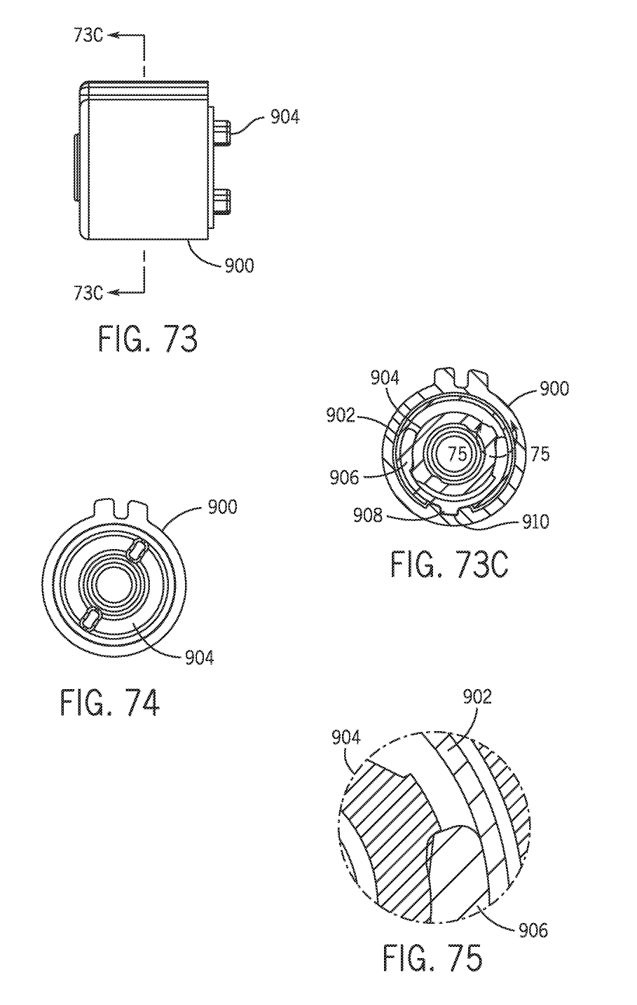

FIGS. 67-75 show another embodiment of a variable rate friction damper 60 in accordance with the invention. Variable rate friction damper 60 includes a housing 900, a spring clip 902, a rotor 904, and a sleeve 906. Unlike some previously described embodiments where a rotor directly contacts a spring clip, variable rate friction damper 60 includes a sleeve 906 that is inserted between spring clip 902 and rotor 904. Including sleeve 906 allows a user to select the materials of the rotor 904 and the sleeve 906 to provide preferred friction characteristics. In the preferred embodiment, rotor 904 and sleeve 906 are made of similar materials including but not limited to plastic. As shown, sleeve 906 includes a retention tab 908 that engages a retention slot 910 in the housing, which prevents the sleeve from rotating during use.

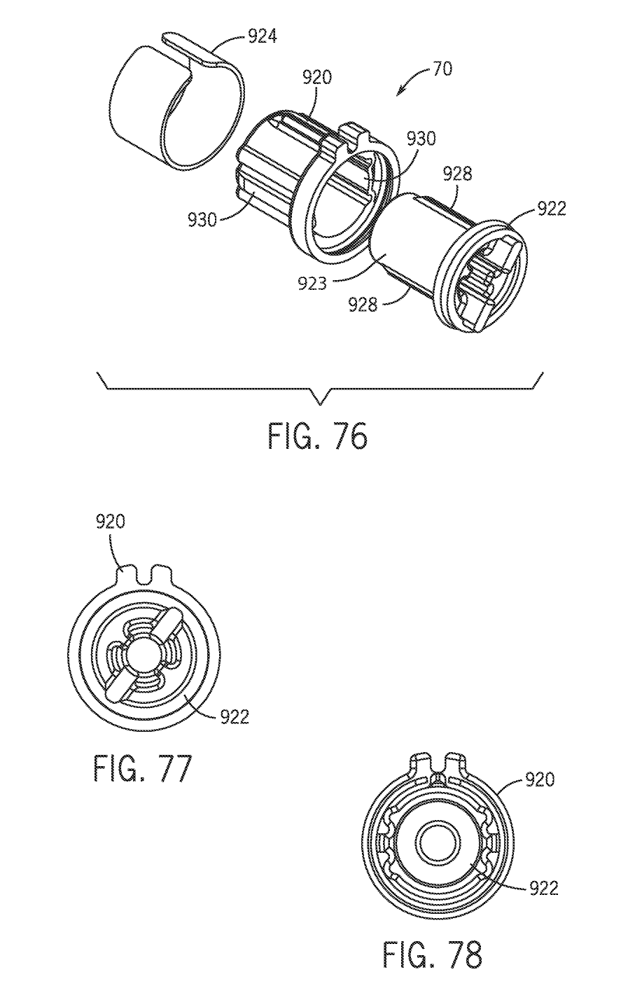

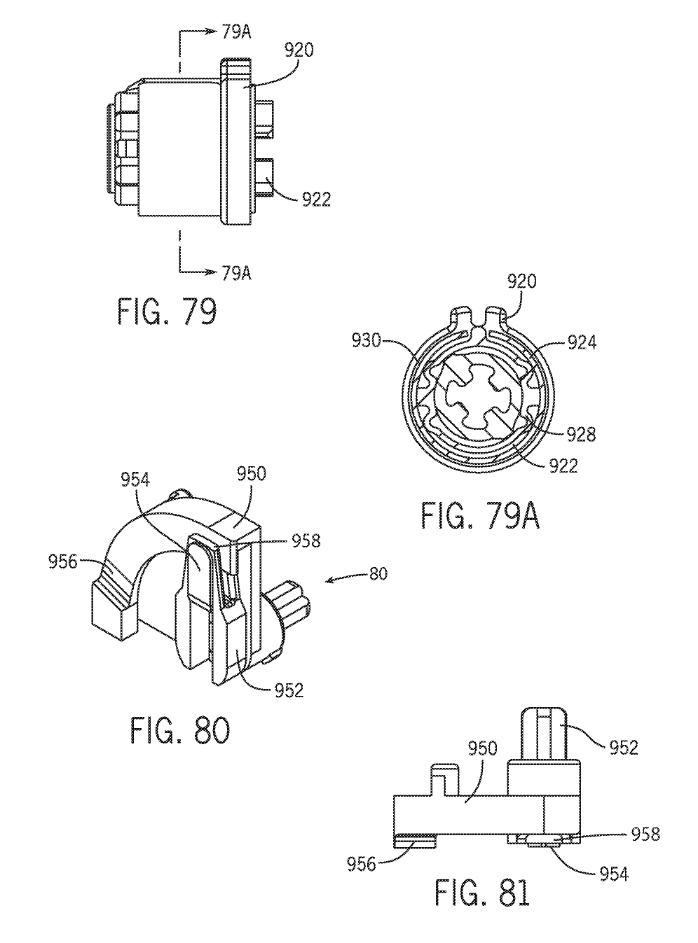

Turning now to FIGS. 76-79, another embodiment of a variable rate friction damper 70 in accordance with the invention is shown. Variable rate friction damper 70 includes a housing 920, a rotor 922, and a spring clip 924. Variable rate friction damper 70 achieves the desirable friction characteristics of variable rate friction damper 60 without the use of a spacer. Unlike previous embodiments where a spring clip is disposed between a rotor and a housing, spring clip 924 is positioned around housing 920, with rotor 922 inside the housing. As in the previous embodiments, rotor 922 includes an outside surface 923 and at least one brake contact lobe 928, each of which contact at least one bearing portion 930 on housing 920. Bearing portion 930 is integrally formed into housing 920 and expands when contacted by a brake lobe 928, which forces spring clip 924 to expand when rotor 922 rotates inside the housing.

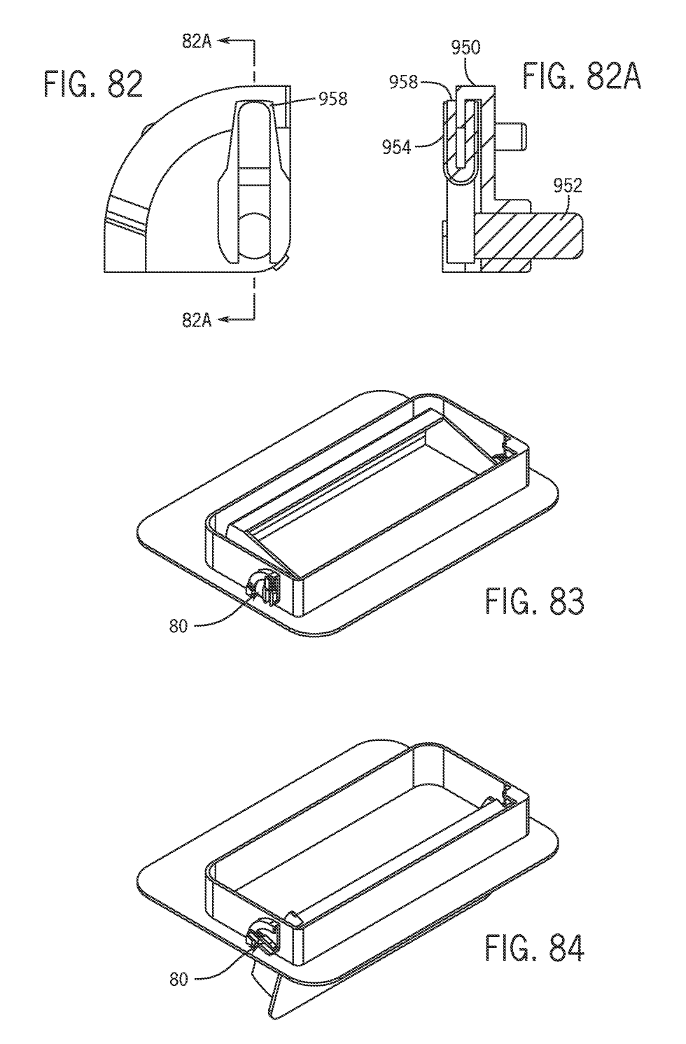

FIGS. 80-84 show another embodiment of a variable rate friction damper 80 in accordance with the invention that is similar in many ways to variable rate friction damper 40 described above. Variable rate friction damper 80 has a base 950, a rotor 952, and a spring clip 954. Base 950 includes at least one ramped surface 956 that engages at least one flexible flange 958 that is integrally formed into rotor 952. Spring clip 954 is attached to rotor 952 so that it provides a clamping force to the at least one flexible flange 958. Unlike variable rate friction damper 40, wherein spring clip 704 contacts base 700, variable rate friction damper 80 allows preferred friction characteristics to be achieved by allowing a user to select whichever materials for base 950 and rotor 952 to provide the desired coefficient of friction, and further allows the user to select the material for spring clip 954 without regard for the coefficient of friction between the spring clip and any other component.

The variable rate friction dampers described above do not include oil or any other material that is susceptible to variations in performance based on temperature. Temperature ranges inside vehicles very wildly, and the variable rate friction dampers disclosed herein are designed to have a generally consistent torque rate across a temperature range of approximately −40 C to 80 C. To produce a variable rate friction damper with consistent performance throughout a wide temperature range, both the sliding surface friction (the “coefficient of friction”) and the force acting on the sliding surface must remain constant as long as the temperature remains within the range. Of course, consistent performance may also be achieved using a material that has variable sliding surface friction over a temperature range as long as the force acting on the sliding surface is also varying in a way that results in consistent performance. Any of the aforementioned embodiments may be modified to include spring clips that are coated with polytetrafluoroethylene (Teflon), electro plated, overmolded with plastic, or otherwise coated to maintain a temperature resistant coefficient of friction.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A variable rate friction damper comprising:
a housing having a recess;
the recess being generally cylindrical and having an inside surface;
a spring clip having a generally cylindrical shape portion that fits inside the recess but does not contact the inside surface of the recess;
a rotor having a generally cylindrical shape and including a contact lobe; and
the rotor rotatably attached to the housing and having a portion disposed inside the spring clip so that the contact lobe engages an interior surface of the spring clip as the rotor rotates causing the spring clip to expand or contract depending on the direction of rotation.

2. The variable rate friction damper of claim 1, wherein the recess included a spring clip retention slot.

3. The variable rate friction damper of claim 2, wherein the spring clip includes a retention flange engaged with the spring clip retention slot.

4. The variable rate friction damper of claim 1 wherein the spring clip is made of spring steel.

5. The variable rate friction damper of claim 1 wherein the spring clip is made of spring steel at least partially coated with polytetrafluoroethylene.

6. The variable rate friction damper of claim 1 wherein the spring clip further includes at least one braking portion that protrudes into the interior of the spring clip so that when rotor is rotated so that the contact lobe engages the braking portion that dampening torque produced by the spring clip increases more than if the spring clip did not include any braking portions.

7. A variable rate friction damper comprising:
a base having an arcuate portion having a first end and a second end;
a ramped surface having a first thickness at the first end of the arcuate portion and a second thickness at the second end of the arcuate portion;
a rotor rotatably attached to the base; and
a spring clip attached to the rotor and having at least one contact surface engaged with the ramped surface so that as the rotor rotates the at least one contact surface travels along the ramped surface causing the spring clip to expand or contract depending on the direction of rotation.

8. The variable rate friction damper of claim 7, wherein the spring clip is generally U shaped.

9. The variable rate friction damper of claim 7, wherein the spring clip is made of spring steel.

10. A variable rate friction damper comprising:
a housing having a recess;
the recess being generally cylindrical and having an inside surface;
a helical rib running along the inside surface;
a rotor having a generally cylindrical shape and including a helical groove running along an outside surface; and
the rotor rotatably attached to the housing with the helical rib selectively interfering with the helical groove so that the rotor may rotate with respect to the recess and so the interference force increases or decreases depending on the amount of interference between the helical rib and the helical groove.

11. A variable rate friction damper comprising:
a base having an arcuate portion having a first end and a second end;
a ramped surface having a first thickness at the first end of the arcuate portion and a second thickness at the second end of the arcuate portion;
a rotor rotatably attached to the base;
a spring clip attached to the rotor; and
the rotor having at least one flexible portion engaged with the ramped surface so that as the rotor rotates the at least one flexible portion contacts and travels along the ramped surface causing the spring clip to expand or contract depending on the direction of rotation.

12. The variable rate friction damper of claim 11, wherein the spring clip is made of spring steel.
